(19) United States
(12) Patent Application Publication
(10) Pub. No.: US 2026/0171048 A1
(43) Pub. Date: Jun. 18, 2026

(54) ADDITIVELY MANUFACTURED ACOUSTIC VIOLIN

(71) Applicant: Georgia Tech Research Corporation, Atlanta, GA (US)

(72) Inventors: Kevin Lee Kamperman, Atlanta, GA (US); Inseo Park, Atlanta, GA (US)

(21) Appl. No.: 19/419,912

(22) Filed: Dec. 15, 2025

Related U.S. Application Data
(60) Provisional application No. 63/733,760, filed on Dec. 13, 2024.

(51) Int. Cl. G10D 1/02; B33Y 10/00; B33Y 80/00; G10D 3/06

(52) U.S. Cl. CPC G10D 1/02; B33Y 80/00; G10D 3/06; B33Y 10/00

(57) ABSTRACT

An acoustic violin or viola that employs additive manufacturing technology, e.g., selective laser sintering and/or multi-jet fusion processes, to wholly build the body of an acoustic violin (or viola) of a polymer that can match the feel and sounds of wooden violins and violas. The exemplary instrument matches the feel and sound of wooden violins and violas and includes (i) an additively manufactured polymer body as a sound box for amplifying sounds produced by strings, the body having a top and a bottom connected by ribs and having a thickness profile to amplify a pre-defined acoustic profile; and (ii) an additively manufactured polymer neck fixably coupled to the body, the neck having a reinforcing rod that, in combination with the neck, provides a stiffness-to-weight ratio to generate a pre-defined acoustic profile.

### RELATED APPLICATION

This U.S. application claims priority to, and the benefit of, U.S. Provisional Patent Application No. 63/733,760, filed Dec. 13, 2024, entitled “Additively Manufactured Acoustic Violin,” which is incorporated by reference herein in its entirety.

### BACKGROUND

Violin and viola manufacturing is a meticulous craft, blending traditional woodworking with precision, involving carving, bending, and shaping woods like spruce and maple into arched plates and ribs, assembling them into an hourglass-shaped body, fitting internal structures like the bass bar, and finishing with varnish and fittings, a process requiring immense patience and skill, whether done by a solo luthier or in workshops.

Additive manufacturing (AM) is a process that builds three-dimensional objects layer by layer from a digital design, adding material rather than subtracting it, unlike traditional methods. Additive manufacturing has been used to create a violin with new materials to create new sounds. Additive manufacturing has been disruptive in the manufacturing industry by bypassing the painstakingly slow and niche process of manually building traditional wood violins, and thereby promoting mass production. Contemporary violin makers generally seek to replicate the rich sounds and timeless aesthetics of the most distinguished luthiers rather than opting to generate new sounds.

There is a benefit to additively manufacture an acoustic violin that replicates the sounds and timeless aesthetics of old lutherie masters.

### SUMMARY

An exemplary system and method are disclosed that employ additive manufacturing technology (e.g., selective laser sintering (SLS) and/or multi-jet fusion (MJR) processes) to wholly build the major structural components of an acoustic violin (or viola) with a polymer material that can replicate and match the feel and sounds of great wooden violins and violas. The exemplary violin and viola can generate great tone and tonal clarity while being sturdy and having a physical design that matches the feel of wooden violins and violas. Violas can, for example, generate a mellow alto voice, tuned C-G-D-A, while a violin can be tuned in perfect fifths with notes G3, D4, A4, E5.

The “voice” or sound of a violin depends on (i) its shape, (ii) the wood it is made from, (iii) the graduation of the thickness profile of its components, (iv) the varnish that coats its outside surface, and (v) the skill of the luthier in combining these elements. A violin generally is made of spruce top (e.g., Norway spruce), spruce soundboard as the top plate that can provide a high stiffness-to-weight ratio, lightness, and flexibility. A violin's ribs and back are often made of maple wood, which is selected for strength, durability, and tonal qualities. The neck of the violin supports the fingerboard and extends the playing surface of the strings, and is also typically made of maple wood. The bridge plays a pivotal role in sound production, often made from maple, to support the strings and transmit their vibrations to the body. The exemplary instrument, made of a polymer with different acoustic and mechanical properties, employs adjustments to the geometric components of a base design of a violin that allow for the tuning of the polymer 3D printed instrument to closely match the mechanical and acoustic properties of its wooden counterpart in a computer-instructed framework.

The adaptation of violin making by additive manufacturing processes can substantially disrupt the lutherie industry. Professional-sounding instruments with the look and feel similar to mid-level to high-level violins and violas can be produced faster and more economically, and can be provided to students, K-12 schools, string instrument distributors, and other beginner-to-mid-level stakeholders. As the technology matures, largely through iteration, the sound of the polymer violins has the potential to rival those of more traditional mid-tier instruments, which would expand markets both domestically and abroad.

The AM violin is well-suited for rapid mass production while not sacrificing the quality of the sound and feel of the instrument. With traditional lutherie, time invested in a handcrafted violin is often considered to be proportional to the quality of the instrument. With AM processes, the designers are in complete control of all factors of the design and can tune/optimize the shape of the structure in a 3D Computer-Aided Design (CAD) environment to match a desired sound profile. Post-prototype prints would be very similar in relative quality and sound profile. Further advancement of the technology would allow for a consistent suite of violins to be offered, each exhibiting a different flavor of sound—rich, dark, bright, brilliant, etc., depending on the end-user application. Therefore, consumers would have access to a wide variety of sound types for minimal cost compared to a traditional wooden equivalent. The polymer violin is highly durable, easy to maintain, and simple to repair. This makes the AM violins highly desirable for K-12 applications.

An exemplary violin design has been fabricated via additive manufacturing, verified through simulation, and tested in an anechoic environment against traditional wooden equivalents. Special consideration in the design had been taken to accommodate the added ductility and density of the polymer structure relative to wooden instruments.

In an aspect, a fully acoustic violin or viola is disclosed comprising: an additively manufactured polymer body as a sound box for amplifying sounds produced by strings, the additively manufactured polymer body having a top and a bottom connected by ribs to form an hour-glass shape, wherein the top has a sound hole, and wherein the top, bottom, and ribs have a thickness profile to amplify a pre-defined acoustic profile for the sound box; and an additively manufactured polymer neck fixably coupled to the additively manufactured polymer body, the additively manufactured polymer neck having a reinforcing rod (e.g., metallic rod) that, in combination with the polymer neck, provides a stiffness-to-weight ratio to generate tone, tonal clarity, and sound, matching a pre-defined acoustic profile.

In some embodiments, the additively manufactured polymer body and additively manufactured polymer neck have modified thickness and shape to account for the difference in ductility and density of the polymer to match a wooden body and wooden neck of a counterpart of the same design.

In some embodiments, the modified thickness and shape are determined via structural strength and frequency response analysis (e.g., via finite element analysis), and wherein the simulation of the modified thickness and shape confirmed that the additively manufactured polymer body and additively manufactured polymer neck are configured to withstand combined tensions of the strings without deformation or long-term creep.

In some embodiments, the additively manufactured polymer neck terminates at a polymer scroll end forming a pegbox to receive a set of tuning pegs (e.g., wooden or polymer) for attachment, winding, and adjustment to the strings, wherein the pegbox has a set of peg holes each having a set of teeth (e.g., 6, 7, 8, 9, 10, 11, 12, 13, 14 teeth) to mechanically maintain tuning of the peg and strings.

In some embodiments, the additively manufactured polymer body and additively manufactured polymer neck are manufactured using selective laser sintering (SLS), multi-jet fusion (MJR), stereolithography (SLA), or an isotropic additive manufacturing process.

In some embodiments, at least one of the additively manufactured polymer body and additively manufactured polymer neck is made of nylon or an SLA resin.

In some embodiments, the additively manufactured polymer body and additively manufactured polymer neck are dimensioned as a full-size violin or viola.

In some embodiments, the additively manufactured polymer body and additively manufactured polymer neck are dimensioned as a sub-size violin or viola (e.g., 4/4 (full), ¾, ½, etc).

In some embodiments, the additively manufactured polymer body and additively manufactured polymer neck are fabricated as a single unitary polymer body.

In some embodiments, the additively manufactured polymer body and additively manufactured polymer neck are fabricated as two components that are joined.

In some embodiments, the additively manufactured polymer neck is printed with a rod channel for insertion of the reinforcing rod, wherein the channel and reinforcing rod extend between a bottom end of the additively manufactured polymer neck (including the dovetail joint portion) and a top end of the additively manufactured polymer neck.

In some embodiments, the top of the additively manufactured polymer body has a uniform thickness plate that is supported by a bass bar and a sound post, wherein the bass plate is elongated to that of a counterpart of the same design to withstand downwards forces from a bridge positioned over the bass bar and a sound post.

In some embodiments, wherein the additively manufactured polymer body has a first portion of a joint (e.g., a dovetail joint), wherein the additively manufactured polymer neck has a second portion of the joint (e.g., a dovetail joint), and wherein counter-torque fasteners are employed (e.g., to resist the torque incurred on the neck by the strings).

In some embodiments, the additively manufactured polymer neck includes an additively manufactured polymer fingerboard.

In another aspect, a method of manufacturing a violin or viola is disclosed comprising: printing an additively manufactured polymer body (e.g., via using (SLS), multi jet fusion (MJR), Stereolithography (SLA), or equivalent isotropic process) as a sound box for amplifying sounds produced by strings, the additively manufactured polymer body having a top and a bottom connected by ribs to form an hour-glass shape, wherein the top, bottom, and ribs has a thickness profile to amplify a pre-defined acoustic profile for the sound box; printing an additively manufactured polymer neck, the additively manufactured polymer neck having a reinforcing rod channel for placement of a reinforcingrod that, in combination with the polymer neck, provides a stiffness-to-weight ratio to generate tonal clarity and sound matching a pre-defined acoustic profile; attaching the additively manufactured polymer neck to the additively manufactured polymer body; and installing the reinforcing rod into the reinforcing rod channel.

In some embodiments, the additively manufactured polymer body and additively manufactured polymer neck are manufactured using selective laser sintering (SLS), multi-jet fusion (MJR), stereolithography (SLA), or an isotropic additive manufacturing process.

In some embodiments, the method includes determining, via structural strength and frequency response analysis and modal simulations, thickness and shape of the additively manufactured polymer body and the additively manufactured polymer neck, wherein the structural strength and frequency response analysis and modal simulations determine the thickness and shape can withstand combined tensions of the strings without deformation or long-term creep for the additively manufactured polymer body and the additively manufactured polymer neck.

In some embodiments, the additively manufactured polymer body and additively manufactured polymer neck are fabricated as a single unitary polymer body.

In some embodiments, the additively manufactured polymer body and additively manufactured polymer neck are fabricated as two components that are joined, wherein the additively manufactured polymer body has a first portion of a dovetail joint, and wherein the additively manufactured polymer neck has a second portion of the dovetail joint.

In some embodiments, the additively manufactured polymer neck includes at least one of: an additively manufactured polymer fingerboard, a set of additively manufactured polymer pegs, an additively manufactured polymer chin rest, and an additively manufactured polymer tailpiece.

### BRIEF DESCRIPTION OF THE DRAWINGS

FIG. 1 shows an example fully acoustic violin manufactured to provide wholly built structural components made with a polymer material that can replicate and match the feel and sounds of great wooden violins and violas in accordance with an illustrative embodiment.

FIG. 2 shows an example method of fabrication of the violin (or viola) of FIG. 1, in accordance with an illustrative embodiment.

FIGS. 3A and 3B show examples of the fabrication and installation of the violin polymer neck with a reinforcing rod.

FIGS. 4A-4C show examples of additional polymer-based fabricated components that may be employed in the polymer violin.

FIGS. 5A-5B show the polymer neck, peg box, and course tuning pegs design for attachment, winding, and adjustment to the strings.

FIG. 6 shows the polymer body design to accommodate forces applied by the bridge.

FIGS. 7A-7G show CAD drawings of an example polymer-based 3D printed violin.

FIGS. 8A-8D show the design of a polymer violin developed in a study.

FIGS. 9A-91 show static strength analysis via finite element modeling analysis performed in the study for a set of violin designs.

FIGS. 10A-10C show the modeling and validation of the violin neck and course tuner peg design conducted in the study.

FIGS. 11A-11H show anechoic chamber setup and test results collected in the study.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

### Example Apparatus

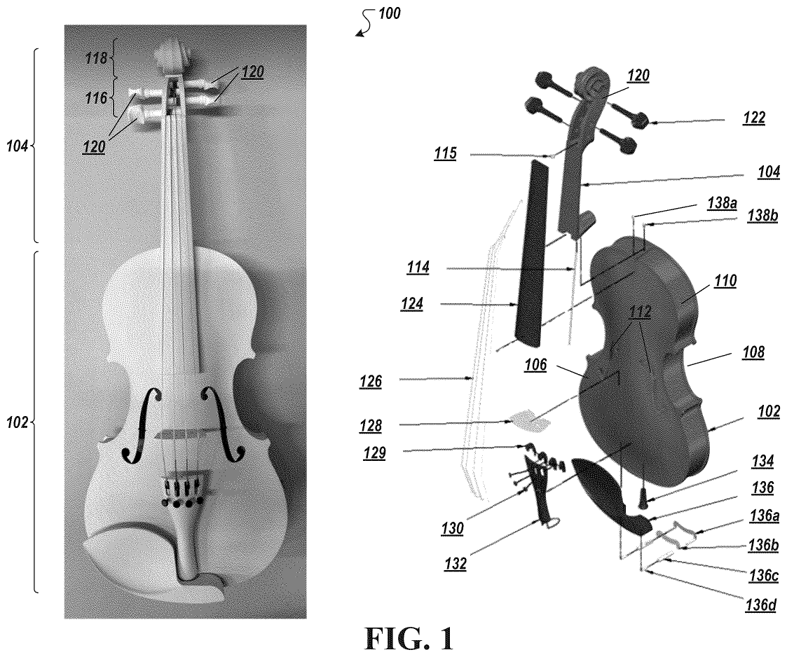

FIG. 1 shows an example fully acoustic violin 100 (or viola) that was manufactured to provide wholly built structural components made with a polymer material that can replicate and match the feel and sounds of great wooden violins and violas in accordance with an illustrative embodiment. The exemplary violin and viola can generate great tone and tonal clarity while being sturdy and having a physical design that matches the feel of wooden violins and violas.

In the example shown in FIG. 1, the acoustic violin 100 includes an additively manufactured polymer body 102 and an additively manufactured polymer neck portion 104. The polymer body 102 and polymer neck portion 104 have modified thickness and shape to account for the difference in ductility and density of the polymer to match a wooden body and wooden neck of a counterpart of the same design.

The polymer body 102 is a sound box for amplifying sounds produced by strings. It has a thickened polymer wall (as compared to a wooden counterpart of the same design to provide similar stiffness and acoustic properties. The body 102 has a top 106 and a bottom 108 connected by ribs 110 to form an hour-glass shape. The top 106 has a sound hole 112. The top 106, bottom 108, and ribs 110 have a thickness profile to amplify a pre-defined acoustic profile for the sound box. In FIG. 1, the body 102 and neck portion 104 are printed as two or more components. In other embodiments, a single unitary body may be fabricated. The neck 104 has included a reinforcing rod 114 (e.g., threaded rod) that, in combination with the neck 104, provides a stiffness-to-weight ratio to generate tone, tonal clarity, and sound, matching a pre-defined acoustic profile. The reinforcing rod 114 may be made of a metallic rod (e.g., stainless steel, etc.). The reinforcement pod 114 may be attached a treaded insert (e.g., 138a) at one end and fixed to the neck 104 with a connector 115 (e.g., nut).

The neck portion 104 includes a peg box region 116 and a scroll end 118. The peg box region includes peg holes 120 to receive a set of pegs 122. The neck portion 104 may also have or be attached to a sound bar 124 (also referred to as a fingerboard). Each of the 4 strings 126 extends between pegs 122 over the fingerboard 124 across a bridge 128 and terminates at a fine tuner 129 and pegs 130 of a tailpiece 132. The violin 100 also includes an endpin 134, and a chinrest 136 and corresponding clamp components 136a-136d. The endpin 134, chinrest 136, tailpiece 132, and bridge 128 may be made of a polymer or be made of other commercially available violin parts for the same without substantially affecting the performance and/or cost of the polymer-made violin, where the main manufacturing resources and cost are associated with the body 102 and the neck portion 104.

In the example shown in FIG. 1, the neck portion 104 and the body 102 are connected together at a dovetail joint. The dovetail joint on the body 102 includes one or more threaded/heat inserts 138 (shown as 138a, 138b) to which the dovetail joint of the neck portion 104 includes holes through which a connector can couple the neck portion 104 to the body 102.

The additively manufactured polymer body and additively manufactured polymer neck may be manufactured using selective laser sintering (SLS), multi-jet fusion (MJR), stereolithography (SLA), or an isotropic additive manufacturing process. At least one of the additively manufactured polymer body and additively manufactured polymer neck is made of nylon or an SLA resin. The additively manufactured polymer body and additively manufactured polymer neck may be dimensioned as a full-size violin or viola. In some embodiments, the additively manufactured polymer body and additively manufactured polymer neck may be dimensioned as a sub-size violin or viola (e.g., 4/4 (full), ³4, 12, etc.).

In some embodiments, the additively manufactured polymer body 102 and additively manufactured polymer neck 104 are fabricated as a single unitary polymer body. In alternative embodiments, the additively manufactured polymer body 102 and additively manufactured polymer neck 104 are fabricated as two components that are joined. The size may be constrained by the 3D printing system and its size limitations. The additively manufactured polymer neck 104 may include an additively manufactured polymer fingerboard (singularly or separately printed with the neck 104). In some embodiments, the fingerboard may be a wooden component that is attached to the neck 104.

### Method of Fabrication and Assembly

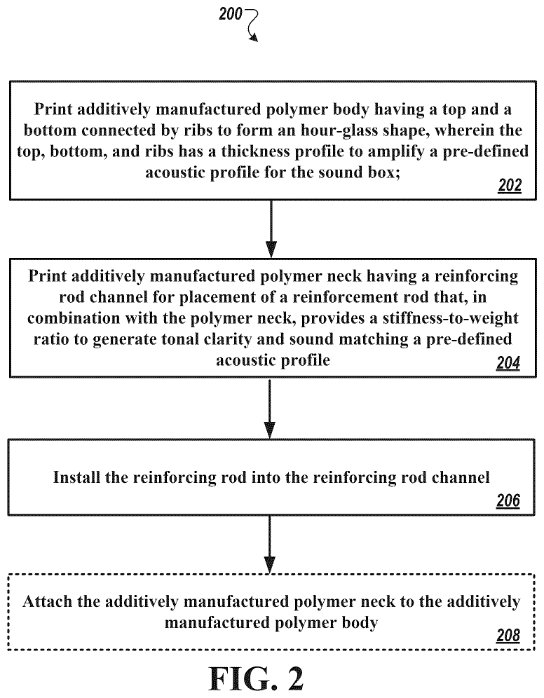

FIG. 2 shows an example method 200 of fabrication of the violin (or viola) of FIG. 1, in accordance with an illustrative embodiment. In FIG. 2, the method 200 includes printing (202) an additively manufactured polymer body (e.g., 102) (e.g., via using (SLS), multi jet fusion (MJR), Stereolithography (SLA), or equivalent isotropic process) as a sound box for amplifying sounds produced by strings, the additively manufactured polymer body (e.g., 102) having a top and a bottom connected by ribs to form an hour-glass shape, wherein the top, bottom, and ribs has a thickness profile to amplify a pre-defined acoustic profile for the sound box. Any isotropic AM process may be employed.

Method 200 then includes printing (204) an additively manufactured polymer neck (e.g., 104), the additively manufactured polymer neck (e.g., 104) having a reinforcing rod channel for placement of a reinforcement rod that, in combination with the polymer neck, provides a stiffness-to-weight ratio to generate tonal clarity and sound matching a pre-defined acoustic profile. In some embodiments, the printing operations (202 and 204) are performed in a single printing step, e.g., to create the body 102 and neck 104 as a single unitary structure. In some embodiments, the sound post may be fabricated as a single structure with the body 102.

Method 200 includes installing (206) the reinforcing rod into the reinforcing rod channel.

Method 200 includes attaching (208) the additively manufactured polymer neck to the additively manufactured polymer body.

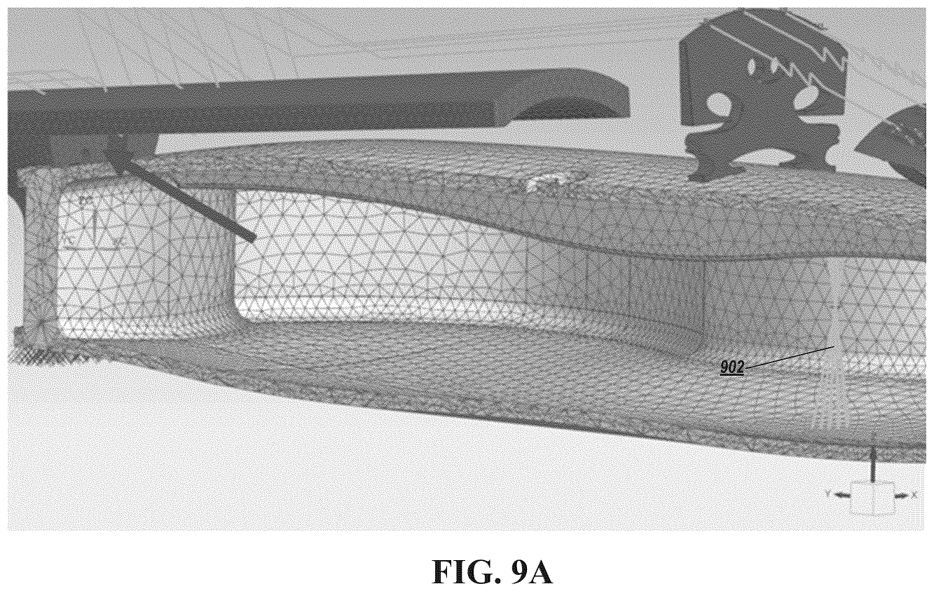

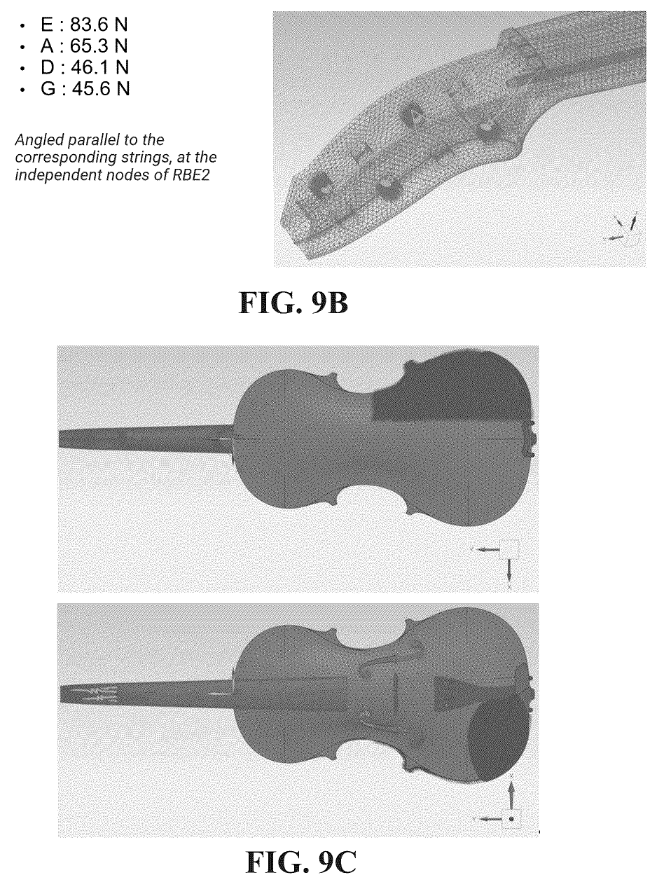

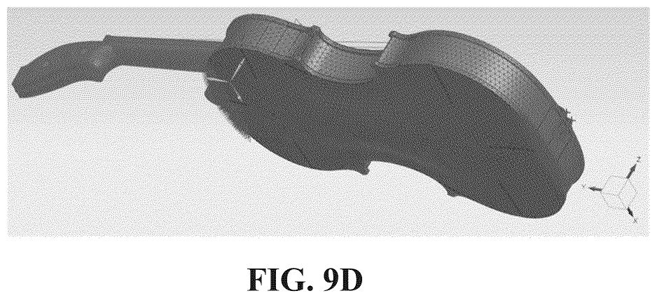

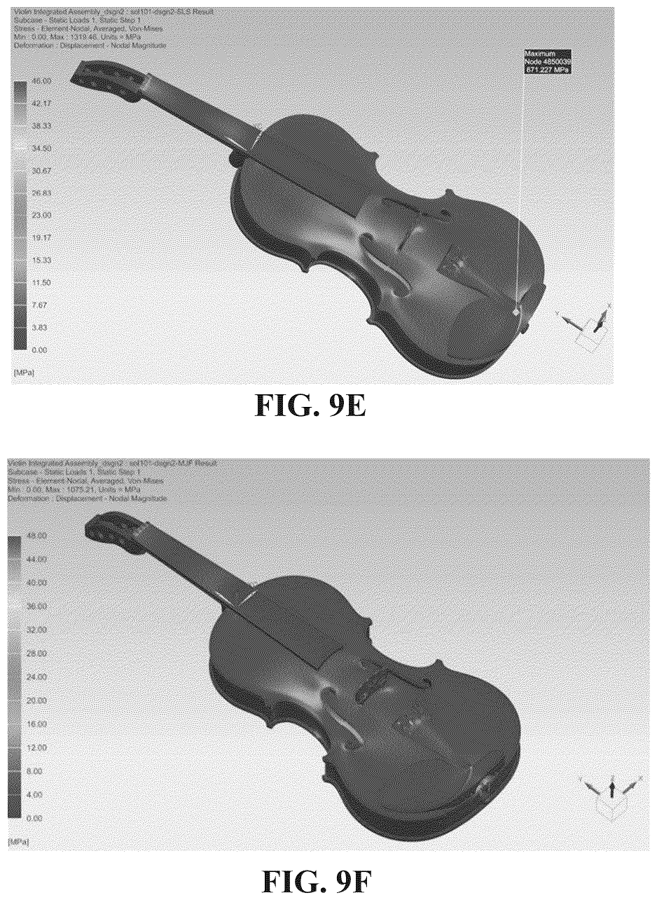

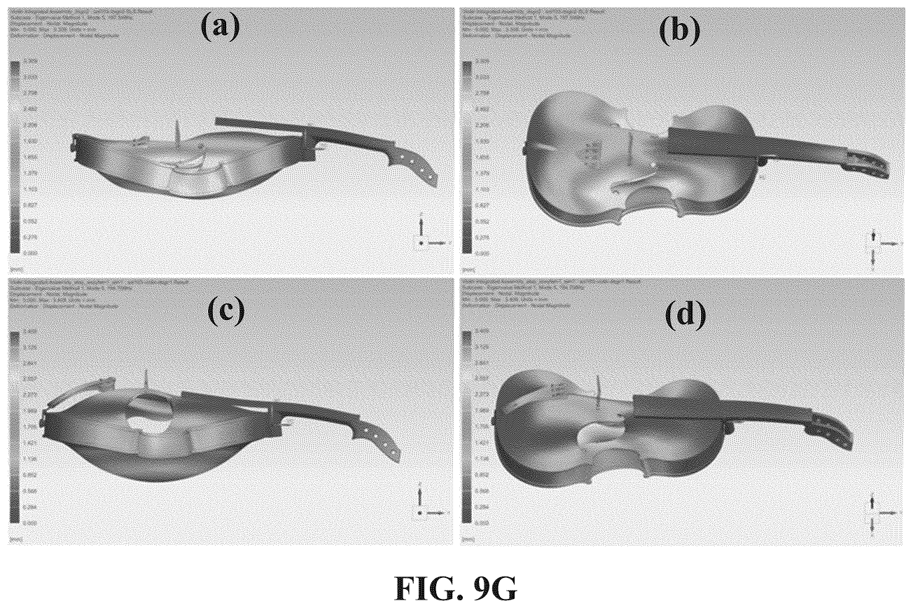

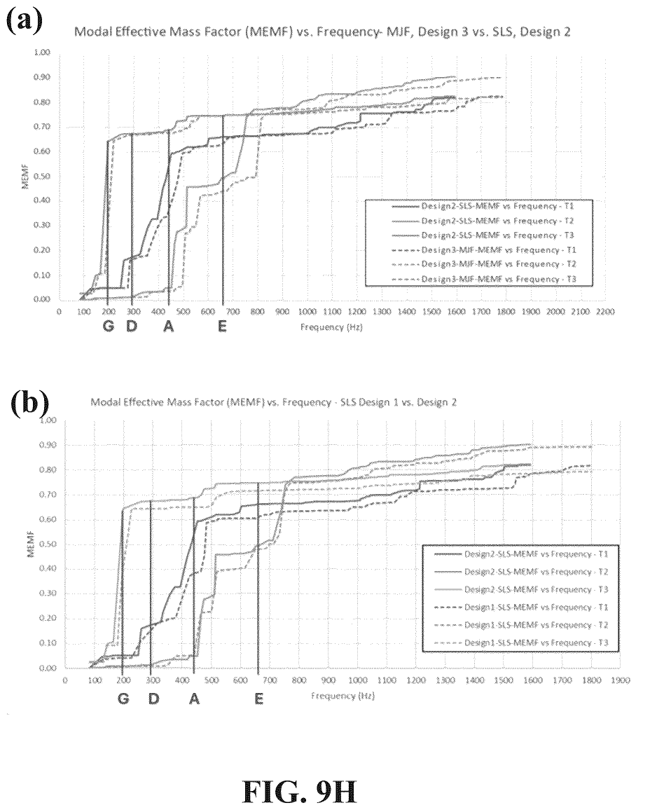

In some embodiments, the method 200 includes determining, via structural strength and frequency response analysis and modal simulations, thickness and shape of the additively manufactured polymer body and the additively manufactured polymer neck, wherein the structural strength and frequency response analysis and modal simulations determine the thickness and shape can withstand combined tensions of the strings without deformation or long-term creep for the additively manufactured polymer body and the additively manufactured polymer neck. An example of the analysis that may be performed, as provided in relation to FIGS. 9, 10, and 11.

The thickness and geometry of the instrument can be modified to provide specific stiffness and mass that provide specific acoustic output. Generally, the natural frequency response can be determined as the square root of the stiffness of the structure over its mass. For the violin, the natural frequency is desired to be within the frequency band of the strings. Nylon material more ductile and dense relative to wooden counterparts, so regions are thickened to improve the ability of the structure to resist the tension of the strings. However, excessive mass lowers the natural frequency of the structure outside of the string band and degrades the feel of the instrument (e.g. too heavy). A delicate balance must be made to leverage structural integrity, tone, and comfort.

The method 200 may be performed additionally for at least one of an additively manufactured polymer fingerboard, a set of additively manufactured polymer pegs (e.g., course tuning pegs), an additively manufactured polymer chin rest, an additively manufactured polymer tailpiece, a soundpost, an endpin, and a bridge.

The exemplary violin and viola can generate great tone and tonal clarity while being sturdy and having a physical design that matches the feel of wooden violins and violas. Violas can, for example, generate a mellow alto voice, tuned C-G-D-A, while a violin can be tuned in perfect fifths with notes G3, D4, A4, E5.

The adaptation of violin making by additive manufacturing processes can substantially disrupt the lutherie industry. Professional-sounding instruments with the look and feel similar to mid-level to high-level violins and violas can be produced faster and more economically. An instrument made of a polymer has different acoustic and mechanical properties and thus a different sound. It's technically non-trivial and non-conventional to reproduce a wooden instrument with a polymeric one while preserving feel/touch and sound as compared to creating a new instrument with a new sound (as it may be less constrained).

### Reinforcement Rod.

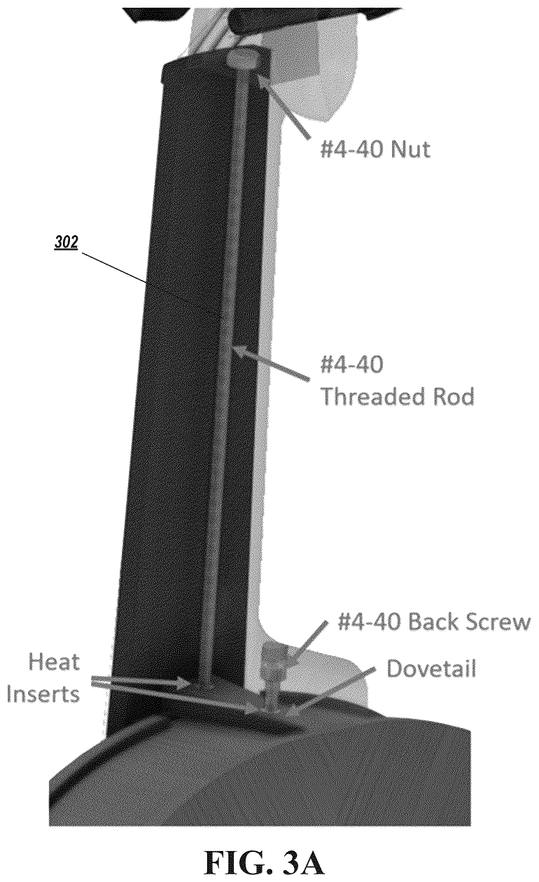

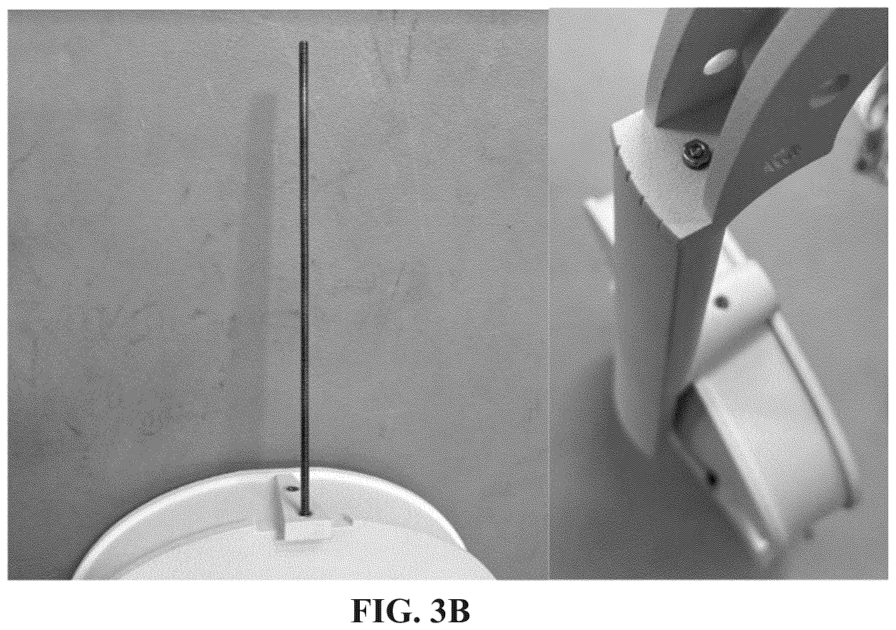

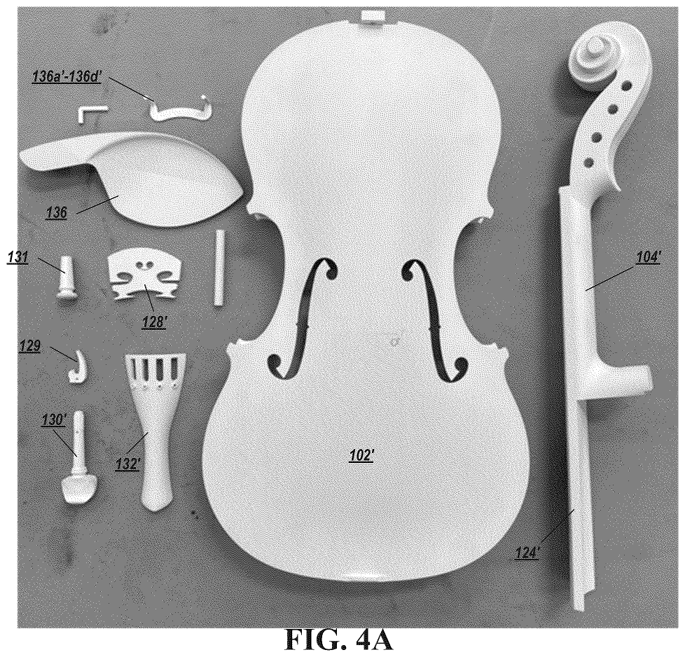

FIGS. 3A and 3B show the additively manufactured polymer neck 104 may be printed with a rod channel 302 for insertion of a reinforcing rod 114 (e.g., metallic rod). In either implementation, the channel 302 and reinforcing rod 114 can extend between a bottom end 304 of the neck 104, including through a joint region (e.g., dovetail region) and the top end 306 of the neck 104. An example reinforcement rod (e.g., 114) may be a #4-40 threaded rod.

To mount the rod 114, as a non-limiting example, the body 102 may include holes (e.g., in a dovetail joint) for heat inserts that can be reamed into the structure and the inserts installed in a thermoplastic. The rod 114 may be threaded into the forward insert, e.g., as shown in FIG. 3A. The neck may then be inserted over the threaded rod (e.g., 114) and gently rocked into place around the dovetail. A washer and nut, or equivalent fastening method, may be installed and torqued.

FIG. 3B shows images of a rod 114 being threaded into the neck (left) and the neck 104 being inserted over the threaded rod (right). Modern violins typically use a dovetail joint to better mate the neck assembly to the body. The joint may have a rectangular boss or may have a sloped dovetail to allow press-fit of the two assemblies. An offset, e.g., of 0.15 mm, may be used to ensure the polymer faces would snuggly mate instead of interfering.

### Other Polymer-Based Fabricated Components

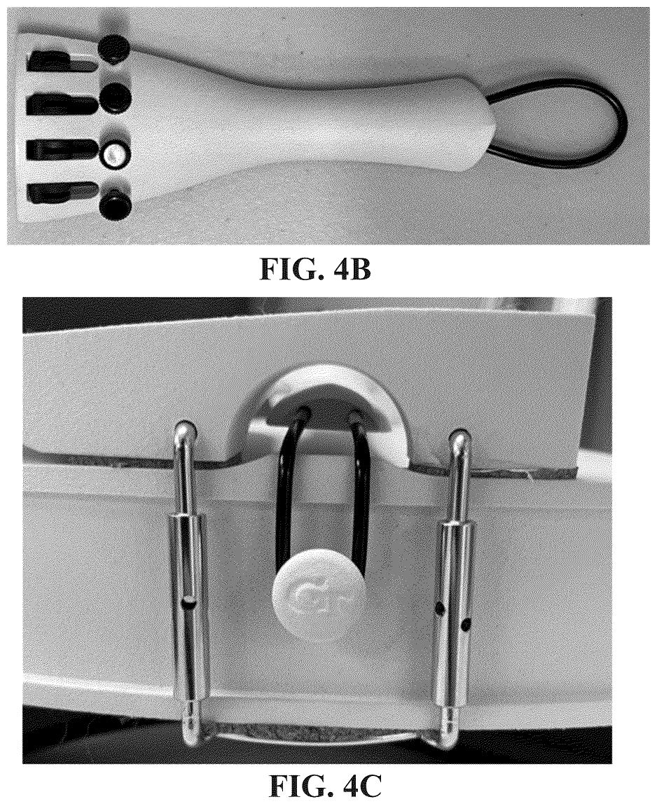

FIGS. 4A-4C shows examples of additional polymer-based fabricated components that may be employed in the polymer violin 100.

FIG. 4A shows examples of polymer-based fabricated components, including neck body 102 (shown as 102′), neck 104 (shown as 104′), fingerboard 124 (shown as 124′), bridge 128 (shown as 128′), fine tuner arm 129, course tuning pegs 130 (shown as 130′), an end pin 131, a tailpiece 132 (shown as 132′), chinrest 136 (shown as 136′) and components (shown as 136a′-136d′). The endpin 134, chinrest 136, tailpiece 132, and bridge 128 may be made of a polymer or be made of other commercially available violin parts for the same without substantially affecting the performance

FIGS. 4B and 4C show an image of the tailpiece 132′ and its installation, respectively. The tailpiece 132′ includes a tailgut, spindle, locking pin, and knobs being installed in the tailpiece assembly. The tailgut may be loosely installed around the endpin 131, and the tailpiece may be left to gently rest on the top plate.

### Scroll and Peg Box and Acoustic Adjustments.

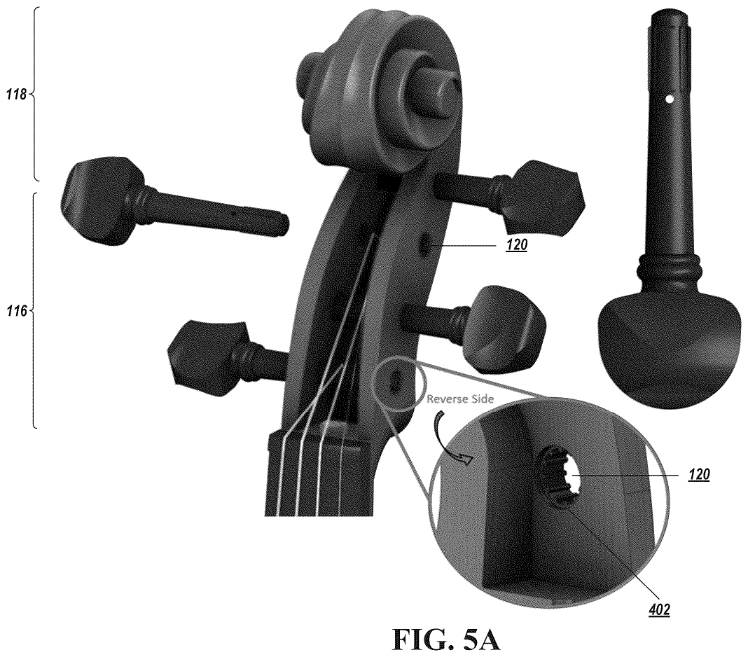

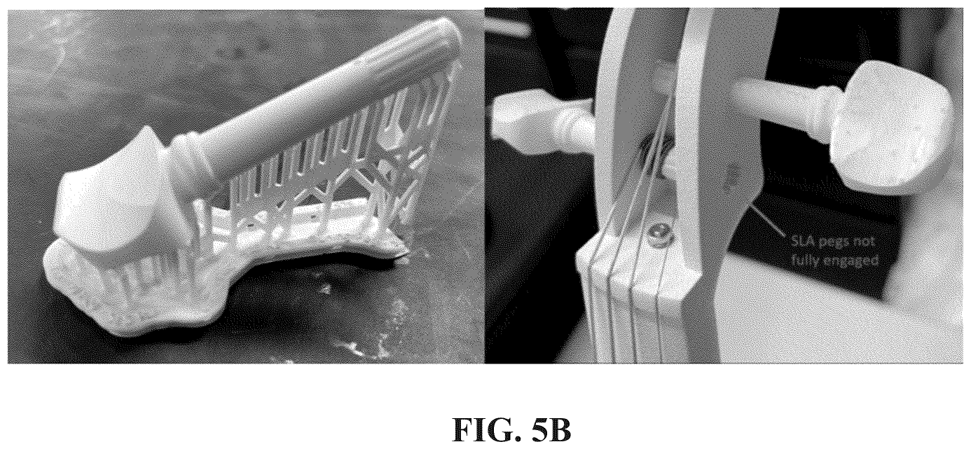

FIG. 5A shows the polymer neck 104 terminating a peg box 116 and scroll end 118 to receive a set of course tuning pegs 122 (e.g., wooden or polymer) for attachment, winding, and adjustment to the strings. The pegbox 116 has a set of peg holes 120 each, in some embodiments, having a set of teeth (e.g., 6, 7, 8, 9, 10, 11, 12, 13, 14 teeth) to mechanically maintain tuning of the peg and strings.

To hold the string under the string load (e.g., over 70 Nm for a string), the course tuning pegs (e.g., 122) and corresponding hole 120 include a set of teeth 402 to prevent slipping, to allow the pegs 122 to hold a tune for a meaningful duration. Raised spokes (or teeth) may be added near the tip of the peg, as shown in FIG. 5A. The spokes/teeth may be configured to not extend to the end of the peg but gently terminate 2.75 mm from the tip to allow the player to use the tip of the peg as a smooth guide while performing coarse adjustments. Once a desirable tune is reached, the peg spokes/teeth may be pushed inward and are engaged with the receiving geometry on the pegbox.

The strings may be hooked inside each peg 122 and neatly wound to a loose tension. The bridge 128 may be installed at a marked position on the top plate 106. Tightening of the strings may be performed gradually. Acoustic violins translate the vibrations of the strings through the bridge, soundpost, bass bar, and the body structure, which vibrate to create air compressions that produce pressure waves. The resultant air compressions occur at the same frequency as the strings, as well as at harmonics, or multiples of the original resonance.

FIG. 5B shows an SLA printed peg with support (left) and the installed SLA pegs (right).

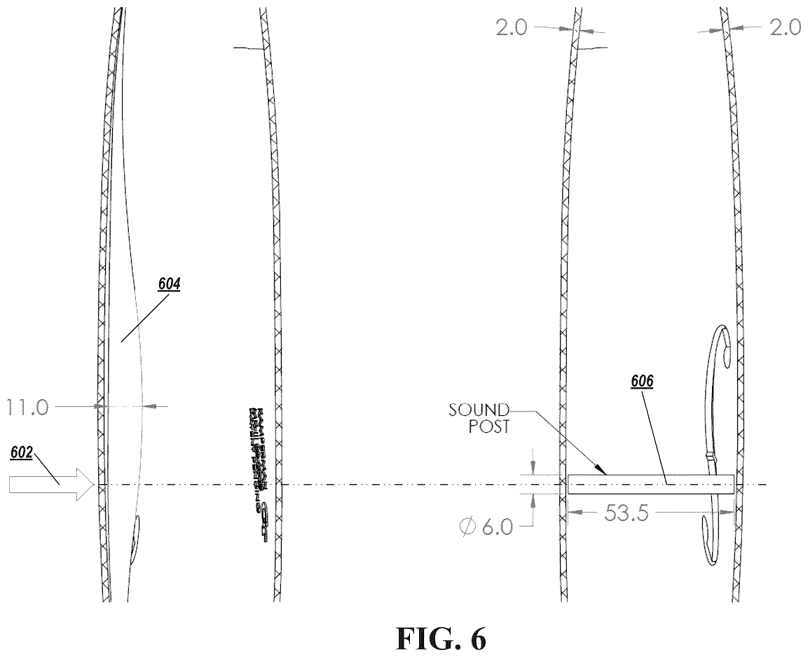

Bridge Support. The tension of the string also puts a force (shown by arrow 602) on the top 106 of the body 102 by the bridge 128. FIG. 6 shows the cross-section of the top 106 of the body 102 and the bottom 108. The top 106 is shown having been made of a uniform thickness plate that is supported by a bass bar 604 and a sound post 606. The bass bar 604 is elongated in thickness to that of a counterpart of the same design to withstand downwards forces from a bridge positioned over the bass bar and a sound post.

In some embodiments, the top 106 may or may not have variable thickness with respect to the rest of the top plate 106.

Simulation and design. The modified thickness and shape are determined via structural strength and frequency response analysis and modal simulations (e.g., via finite element analysis), and wherein the simulation of the modified thickness and shape confirmed that the additively manufactured polymer body and additively manufactured polymer neck are configured to withstand combined tensions of the strings without deformation or long-term creep. While FEM is a standard analysis performed for mechanical designs, it is not conventionally used for lutherie that builds a violin as a subtractive process of removing wood to shape it for certain acoustic properties, rather than an additive process that is compatible with 3D and additive printing technology.

### Example Violin Design

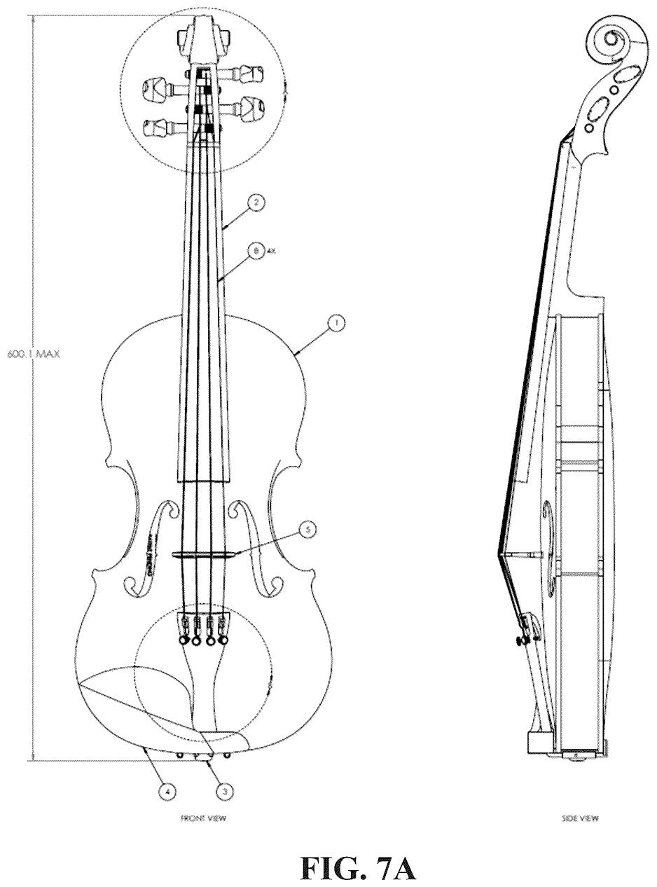

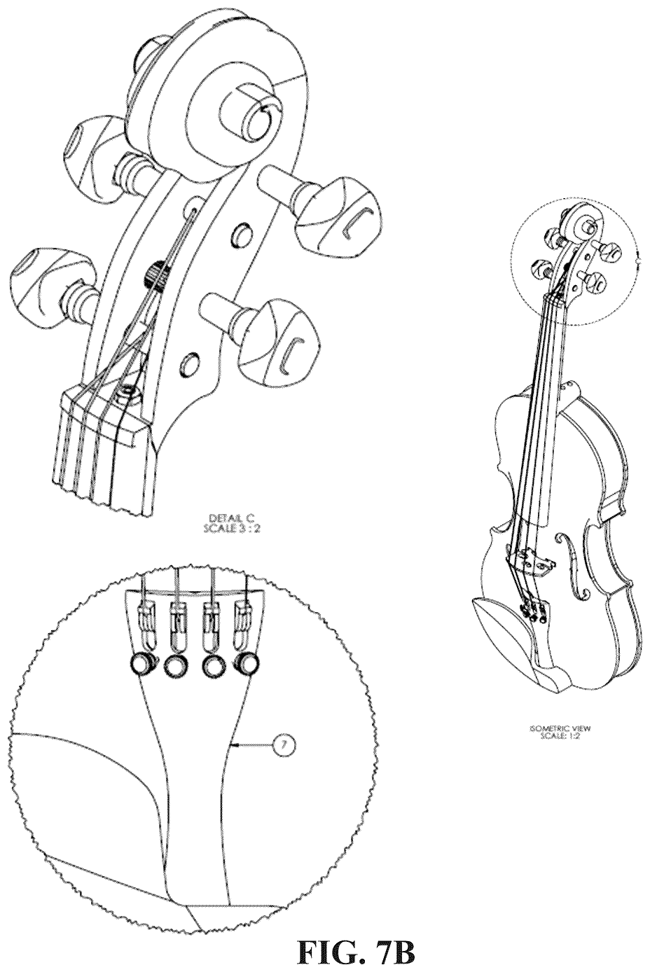

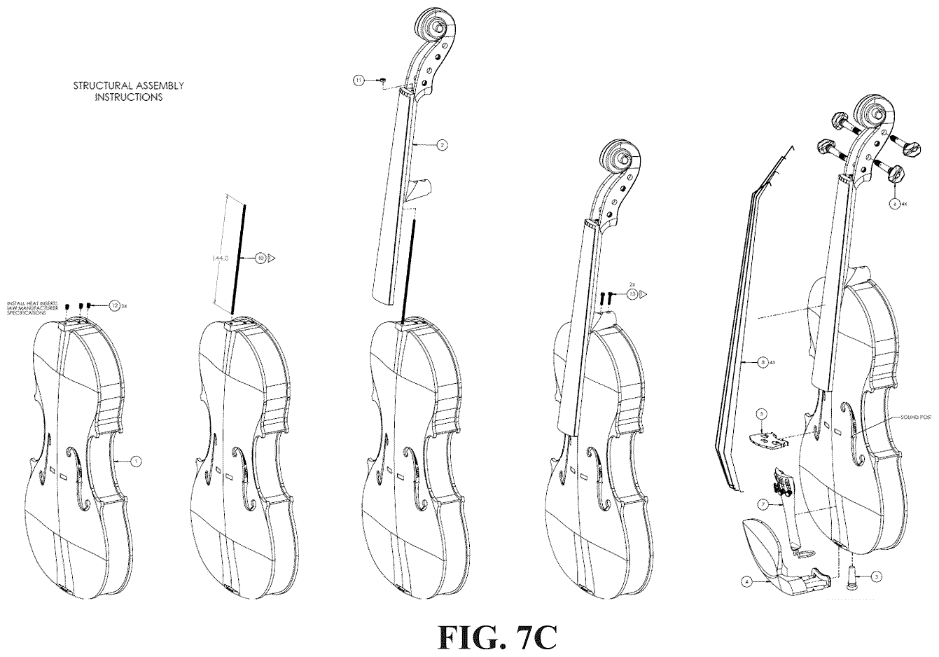

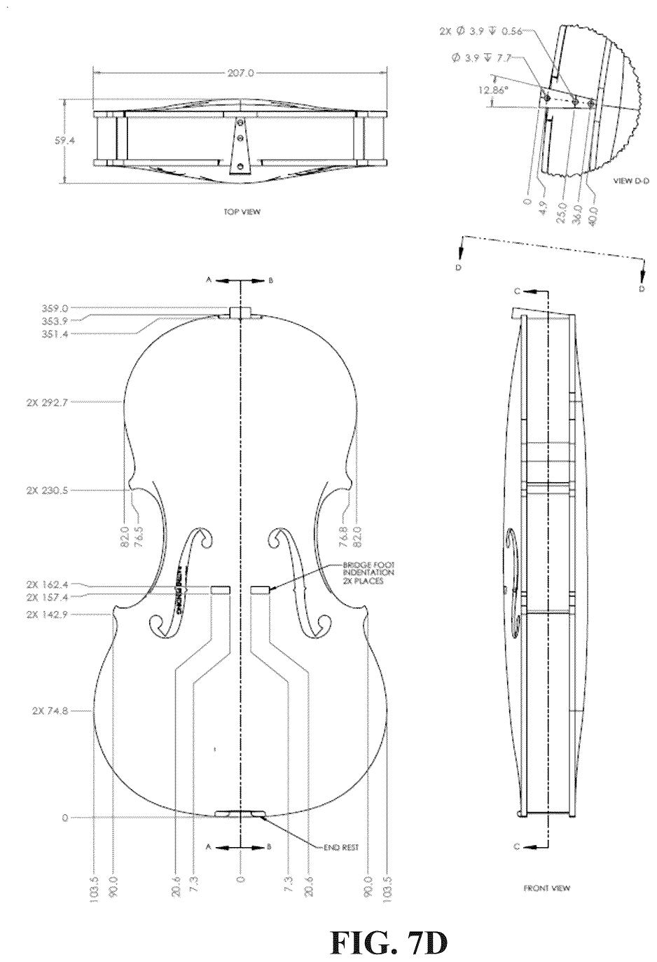

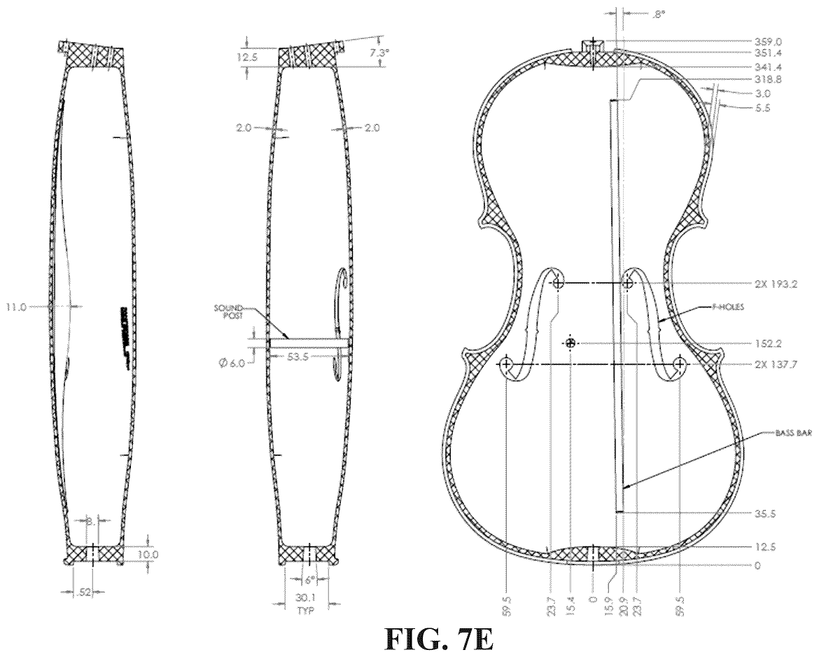

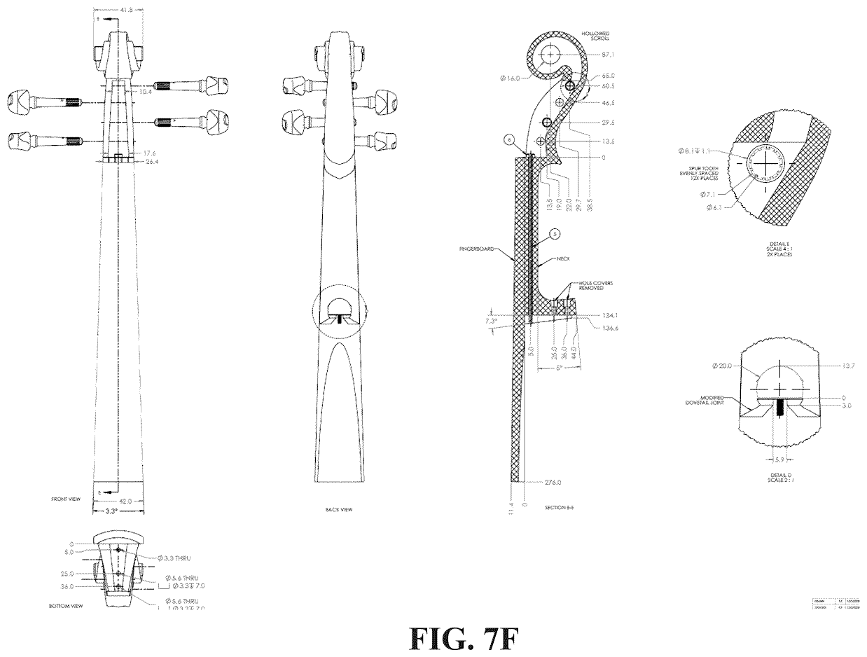

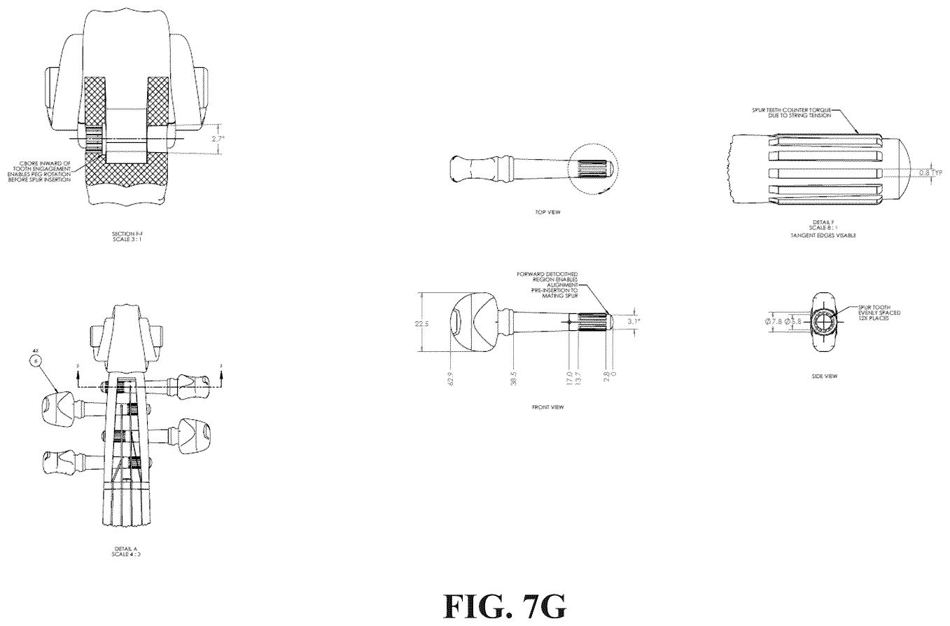

FIGS. 7A-7G show CAD drawings of an example polymer-based 3D printed violin. The dimensions for a full 4/4 violin is provided. For ¾ or ½ sized violins, the dimensions such as length and width may be adjusted but the thickness and subcomponent dimensions (e.g., hole dimensions) may be maintained the same. Similar for viola, the length and width may be adjusted but the thickness and subcomponent dimensions may be maintained the same. FEM analysis and acoustic assessment may be performed on the thicknesses and subcomponent dimensions to achieved desired sound quality.

### Experimental Results and Additional Examples

A study was conducted to develop and evaluate a fully realized design, fabrication, and testing of a 4/4 acoustic additively manufactured violin. The study developed three designs. The first design (MK-I) emulated a traditional wooden violin to the greatest extent possible while considering customer needs surveyed from professional violinists. The second design (MK-II) adapted the design for AM by adding: a threaded rod to the neck, a custom neck-body dovetail joint, a counter torque screw, modified course tuning pegs, and thinned geometry. Tensile testing compared the performance of different AM course tuners and identified the 12-spoke design, which was selected for the final design.

The study conducted a modal simulation and concluded that the mass participation of the structure was too low compared to the string frequency band. A parallel FEA stress analysis reported a stiff structure, so the CAD was thinned substantially—especially in the z-direction—to improve the acoustic signature. A second pair of simulations verified an improved frequency response without compromising the structural integrity. Machine availability led to the switching of AM processes from SLS to MJF, which required a final set of simulations to verify the effect of the change. Ultimately, the material properties of the MJF nylon 12 were found to be close enough to the SLS to have marginal deltas on performance.

The study fabricated, assembled, and tested an example of the MJF violin in an anechoic environment. Anechoic data were collected for the polymer violin and two wooden instruments: a mid-tier and a high-tier. Data collections were performed on each open string, a G-major scale, a legato melody, and an allegro melody. A loudness test confirmed that the polymer violin sound is less intense than its wooden counterparts by 3.0 dB. A series of Dunnwald parameters [20] was established to assign qualitative adjectives to the sound of each instrument from the spectral data. The polymer violin ranked best for each of the parameters for warmth, natality, and brilliance. This matched the qualitative assessments of the professional violinists for the warmth of the D and G strings A and upper E strings were described as more nasal and less brilliant; further modifications may be applied.

Further analysis was performed to make sense of this discrepancy by analyzing the frequency plots of each test directly using the frequency ranges. The polymer violin has a similar spectrum relative to the woods on both the G and D strings, though slightly less ring. The open A has a strong 3rd harmonic, making it sound more nasal. The 4th and 5th harmonics are weaker, leading to a less brilliant sound. The polymer open E has a weak string frequency, leading to the tinny sound unanimously described in the qualitative assessments. The E string has moderate brilliance but less harshness. This assessment indicates that there is likely uncertainty in the calculations of the quantitative Dunnwald parameters, making comparison to violins assessed outside of the population of this study difficult. However, they are still useful for internal comparison between the devices/units under test (referred to as UUT-1/2/3).

To improve the sound quality across each string, especially the A and upper E, the study determined that the plates of the violin body can be thinned to decrease the overall mass of the violin in the z-direction. An iterative approach may be employed for the thinning to not remove too much material and compromise the structure. If less mass can be removed than the acoustics demand, topologically optimized support structures may be employed to mitigate mass but maximize structural integrity. The soundpost may also be permanently fixed to the design during printing to improve the sound translation and overall maintainability of the instrument.

The study determined that the violin performed admirably for an initial prototype print. The study also determined improvements to enhance the structure and playability. First, while the neck structure did not deform, the study determined that a larger or second or additional counter-torque screw may be added to better resist the rotation of the neck. The screw could only be fastened to less than 3.0 N of torque to prevent failure around the heat inserts, so adding more surface area will tighten up the overall joint. This ensures that the fingerboard elevation remains correct, which is vital to playability. Second, the feet of the bridge should mate to a designated boss on the top plate that can clearly show the location of the bridge and reduce slippage during tuning.

### Study Discussion.

The art of acoustic violin lutherie, or violin making, is a highly specialized, traditional, and time-intensive field that has transcended generations. To this day, contemporary violin makers still seek to replicate the rich sounds and timeless aesthetics of the most distinguished luthiers, such as Nicolo Amati or his protege Antonio Stradivari. The latter is perhaps the most famous of all, and thousands of replicas have been made over the past 350 years in vain, all attempting to capture the elusive “secret” of Stradivari's quality work. Notes, procedures, or other trade secrets were scarcely written down by the luthiers of old, so little remains in terms of documentation regarding Stradivari's work, other than the violins themselves. Close to 650 of the master luthier's instruments are still in use today by the world's best violinists, each with an estimated worth of $8-20 million, so there have been ample samples available to study the instruments by more modern scientific means [1]. Scientists have analyzed the composition of the wood, varnish, shapes, and other features Stradivari employed in his violins, and have taken detailed measurements/scans to render the instruments in 3D space. Yet, despite all the studies, reconstructions, and comparisons to other luthiers, no one has yet discovered the secret formula for how to perfectly construct a true Stradivarius violin. To this day, the Stradivarius design, as best as it is known, is the standard for violin making, with the majority of contemporary designs based on one or several elements of the most famous violins of all time.

At a high level, a violin produces sound by amplifying the minute vibrations of thin strings when excited by the coarse hairs of a bow. The strings themselves have little surface area and thus make little sound. The string vibrations are transferred through the bridge, which is held in place singularly by the downward force of the strings. The energy transferred through the bridge deforms the structure, oscillating it back and forth. The feet of the bridge transfer this rocking motion into the top plate, which is weakened by the f-holes to allow for more mass participation at its center. A bass bar located slightly offset from the bridge on the underside of the top plate supports the belly from collapsing due to the downward force from the bridge. Some of the energy is transferred to the bottom plate through the soundpost, and the entire structure vibrates. The oscillating structure has a much greater surface area than the strings and generates waves that excite the surrounding air. Just as the strings themselves have a natural frequency at which they produce the most vibration and sound, called resonance, so do each of the components of the violin. If the resonant frequency of a given component, such as the top plate, matches that of the string frequency, the string amplification is maximized. Harmonics, or overtones, are dampened multiples of the string frequency. A quality violin will amplify the string frequency as well as desirable harmonics, all of which affect the overall sound quality. While a traditional luthier uses subtractive manufacturing methods to alter the resonant threshold of components, modern computer simulation tools can predict the frequency response of a structure. Therefore, a high-fidelity simulation may allow designers, like those in this study, to determine the optimal shape and densities of parts to produce an optimal sound.

The intent of this work is to adapt the violin as perfected by the great luthiers to a more modern manufacturing process. Additive manufacturing (AM) has the potential to drastically change the business of lutherie, as it can bypass the painstakingly slow and niche process of manually building traditional wood violins, and thereby promote mass production. While it is unlikely that an AM-based acoustic violin can replicate the classic full traditional sound of a wooden equivalent, the sound quality should be sufficient for beginner to intermediate-grade instruments, especially due to the precedence of learning the correct posture and technique before enhancing the quality of tone.

For many, the cost of renting or purchasing a string instrument forms a significant barrier to entry. Schools with orchestra programs struggle to purchase and maintain the number of wood instruments required to meet demand. Employing AM processes not only mitigates financial barriers to entry for intermediate players but also allows for the exploration of new sounds. A polymer-based violin may hold a different sound than a wooden Stradivarius replica, but deviation from tradition is not intrinsically wrong and may allow room for new sounds to permeate a wood-only market. Some may also seek the sound and conveniences of an electric violin, but the aesthetics of an acoustic. In such cases, an acoustic AM design could easily be retrofitted as an electric instrument.

An objective of the study includes the design, analysis, and data collection of an AM-based acoustic violin (excluding the bow). The study went through three design phases: (i) design a violin in a 3D computer-aided design (CAD) environment as faithfully to a traditional acoustic model as possible, including elements from the Stradivarius design, as well as other more contemporary designs. As needed, certain elements of the design shall remain non-AM-based for practicality, such as the strings, fine-tuning knobs, tailpiece loop, internal identification sticker, etc. (ii) perform finite element analysis (FEA) on the violin neck to ensure the stresses induced by the tightened strings do not warp the neck structure. This can lead to difficulties holding a tune and long-term fatigue distortion in the neck. Modal analysis was performed in the resonant chamber to determine the mass participation of the individual modes. (iii) Post-fabrication, the AM-based violin shall be acoustically compared to a wooden equivalent. Variables such as loudness (dBA) and pitch over time shall be measured. To improve results, testing may be completed in an anechoic chamber, though this is not required for data collection. Furthermore, testimony from a professional violinist or luthier will be solicited to qualitatively compare the AM-based subject to more traditional sounds.

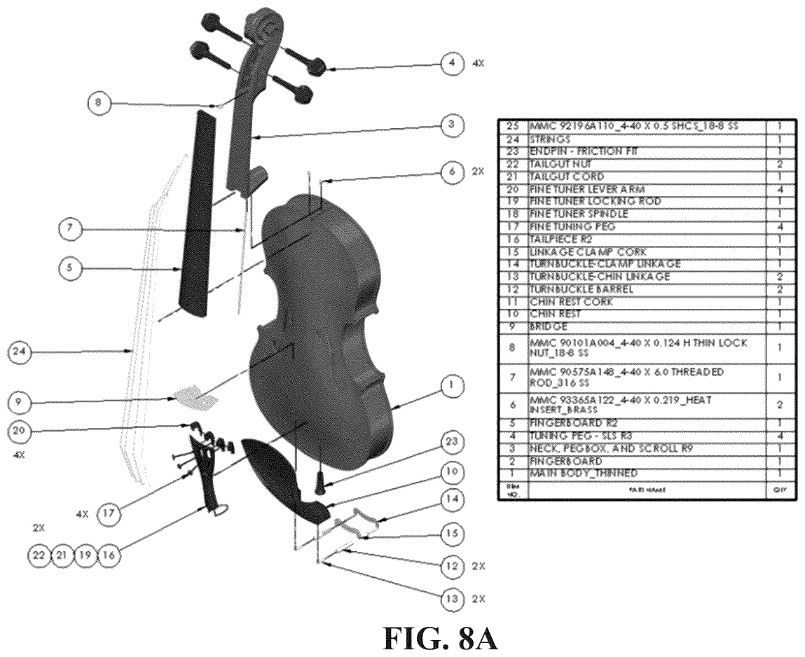

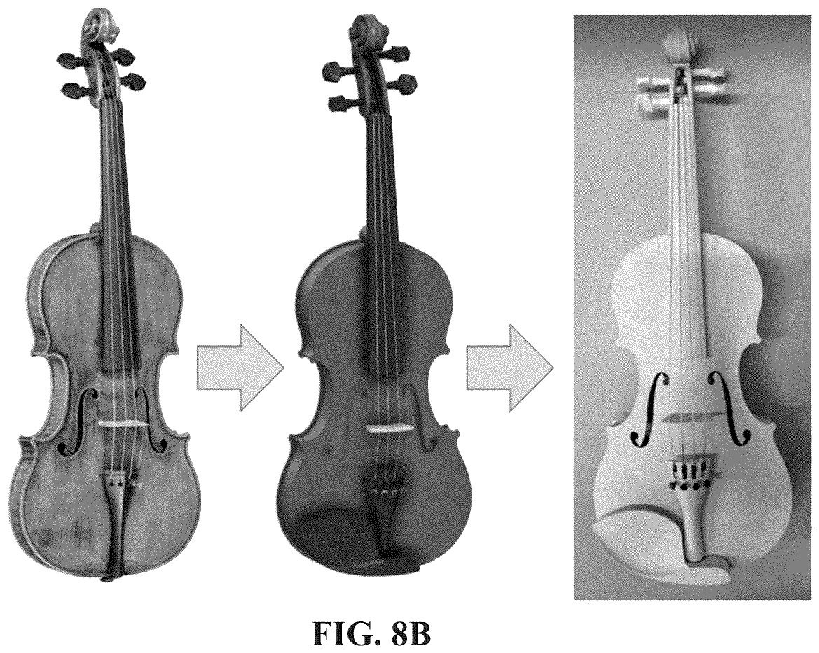

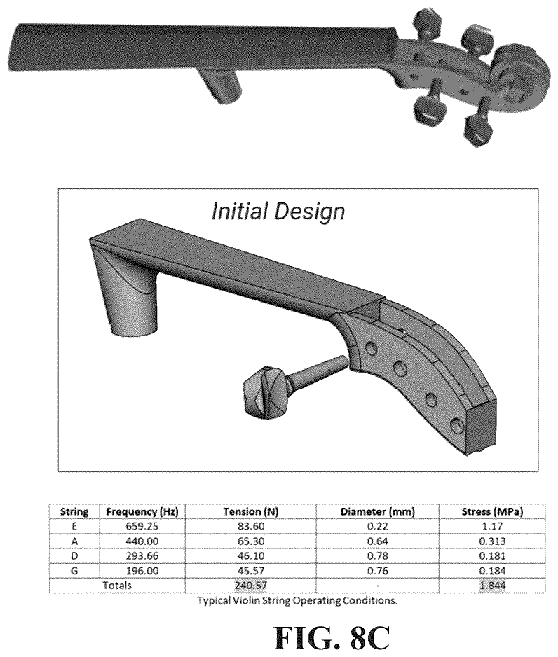

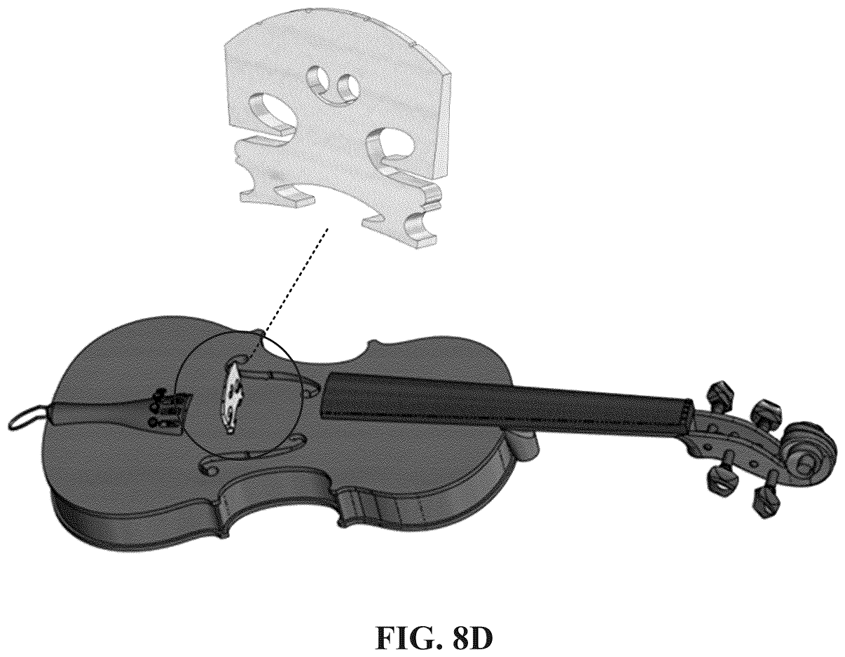

FIGS. 8A-8D shows the design of a polymer violin developed in a study. FIG. 8A shows an exploded view of a final assembly and a bill of materials (BOM) of a fully acoustic polymer developed in the study. FIG. 8B shows the design approach. A physical wooden violin was drafted as a CAD model, to which a physical additive-manufactured polymer violin was 3D printed and assembled. FIG. 8C shows a replicative neck and fingerboard design. FIG. 8D shows a bridge profile employed for the violin. The bridge is a common bridge design. It was determined that even with the same geometrical design as a wooden equivalent, the difference in density of the nylon 12 material will alter the sound propagation through the violin material, invariably resulting in significant tonality differences. A wooden bridge is used with the manufactured violin.

### Preliminary Design.

To best emulate the density (resonant modes) of the hardwoods that comprise traditional violins, the study determined that the density of the ST45 SLA resin (1.12 g/cc) is preferred over the SLS nylon 12 (1.01 g/cc). ST45 also has superior tensile strength (53 MPA) compared to nylon 12 (48 MPA), which is important to resist the stress exerted on the neck by the strings. Furthermore, the smooth surface the SLA resin provides would likely have more positive acoustic properties than the SLS. The prescribed SLA build volume is 192×108×370 mm, or 7.56×4.25×14.67 in (471.3471 in\hat{ }2), and the SLS volume is 200×250×330 mm, or 7.87×9.84×12.99 in (1,005.956 in\hat{ }2). The SLA is the strongest contender in terms of both material and acoustic properties. However, the 14″ L×8.25″ W×2.31″ H violin body (with a separate 9.5″ L×1.75″ W×2.5″ H neck) exceeds the maximum size constraints of most SLA chambers vertically and horizontally, thus SLS is employed for convenience and cost.

The study determined it was undesirable to break up the top and bottom plates, though it is an option if required. The SLS volume shows more promise, as it is almost large enough to print the plates flat across the build plane. The plates may be printed diagonally to compensate, though with degraded strength. The neck, fingerboard, and other smaller parts may be printed adjacent to the plates, within the prescribed volume, and attached in post-processing.

The SLS process also drastically reduces post-processing, as the entire body may be built as one piece without support structures. For either build volume, a violin bow would not fit or function well as a multi-body part. Therefore, the bow is out of context for this project.

A simple first-order calculation was performed to compare the stress exerted on the neck by the strings vs the tensile strength of nylon 12. The analysis provided that the cumulative stress exerted on the neck is approximately 1.84 MPa, compared to the 48 MPa tensile stress of nylon 12. This represents a factor of safety (FOS) of 26, though it is notable that in reality the neck is not in pure tension, and this calculation does not consider fatigue.

Table 1 provides a set of typical violin string operating conditions.

TABLE 1

| String | Frequency (Hz) | Tension (N) | Diameter (mm) | Stress (MPa) |
|---|---|---|---|---|
| E | 659.25 | 83.60 | 0.22 | 1.17 |
| A | 440.00 | 65.30 | 0.64 | 0.313 |
| D | 293.66 | 46.10 | 0.78 | 0.181 |
| G | 196.00 | 45.57 | 0.76 | 0.184 |

| | | | |
|---|---|---|---|
| Totals | 240.57 | — | 1.844 |

The study determined three engineering attributes with the highest critical-to-quality (CTQ) needs, namely, constant tension force of the strings, neck length and profile, and bridge size/shape. After the neck length and profile were identified as a CTQ need, an initial version of the violin was modeled in 3D CAD.

### Violin Body Design

FIGS. 7A-7J show finite element modeling of the violin body design. The modeling was performed and evaluated for 3 designs.

### FEM Configuration of Violin Body and Static Strength Analysis.

FIGS. 9A-9I shows static strength analysis via finite element modeling analysis performed in the study for a set of violin designs. FIG. 9A shows an example of the FEM design. FEM was constructed to perform Solution (SOL) 101 Static Strength Analysis and SOL 103 Modal Analysis in NX, later to be input to NX NASTRAN solver to solve the solution in *.dat file format, and post-processed after inputting the solver results back into NX in *.op2 and *.f06 format. Three-dimensional (3D) tetrahedral elements with 10 nodes (TET10) were used for solids, with at least three nodes along the thickness of the part to properly simulate the through-thickness bending. The scroll area of the pegbox was unmeshed, as the scroll has a negligible impact on FEA results, and having unnecessarily complex geometry often fails the solution. For violin strings, 1D spring elements (CBUSH) were used. The input spring stiffness values were 10⁶ N/mm in X-, Y-, and Z-translation and 10⁵ N*mm in X-, Y-, and Z-rotation per radian, assuming the strings are high-tension strings that are rigid and do not fail under tension loads, similar to metallic fasteners.

The study used rigid body elements (RBE2) to evenly distribute the load applied on the independent node to dependent nodes, assuming the dependent nodes were constrained with infinite stiffness. For example, nodes in the inner surface of the holes in the pegbox area of the violin's neck were configured to be dependent nodes, while the independent nodes were at the center of the corresponding holes, in the same plane as the inner surfaces of the pegbox, parallel to the global YZ-plane. Other locations of RBE2 elements include the fingerboard, the bridge, and the tailpiece lever arms, where the parts interface with the strings. The spring elements in the pegbox area connect the corresponding RBE2 on the pegbox side to the fingerboard RBE2.

In addition, glue simulation objects were used to better simulate the model and for modeling simplicity. The glue allows load transfer between selected bodies, in translation and rotation, fixing the selected bodies together and preventing the bodies from piercing through each other. For both SOL 103 (modal analysis) and 101 (static analysis), the glue simulation objects were applied between: (i) the neck and fingerboard, (ii) the fine tuner spindle and the tailpiece, (iii) the end pin and the body, (iv) the body and tailgut cord, (v) the tailgut cord and the tailgut nut, (vi) the fine tuner spindle and the tailpiece lever arm, (vii) the body and the neck, (viii) the body and the bridge, (ix) the tailgut cord and the end pin, (x) the tailgut nut and the tail piece, and (xi) the tailgut nut 3D elements. More glue simulation objects were added for solution 101 for the body-to-chin rest interface and between the chin rest parts.

The second design cycle using SLS and the third design cycle using MJF involved the addition of the following glue simulation objects: (i) the neck and the threaded rod in the neck (MMC #: 90575A148), (ii) the body and the threaded rod in the neck, and (iii) the body and the vertical support rod are located in the body chamber, close to the bridge. The chin rest was removed for modal 103 runs to better simulate the real test configuration, and 100 or more eigenvalues/modes were requested per design. When deciding which type of simulation object to use, contact simulation objects were also considered, as proper usage of such would allow better displacement-based load transfer. However, including such would unnecessarily elongate the run time and may be excessively sensitive to the coefficient of friction that the solution may fail if the resulting friction force does not prevent the solution from becoming an indeterminate solution, even by a microscopic amount. Hence, the glue simulation objects were used instead.

### FEM Differences Between the Design Cycles.

Design 1 was the baseline design that uses SLS Nylon 12 for the majority of its parts except for the tailgut assembly. In design 1, an RBE3 was used instead of the vertical support rod in the body (see 902, FIG. 9A). This was because RBE3 elements provide a distributed connection, which does not influence the local or global stiffness of the model. This means it may also deflect similarly to the real vertical support rod.

In addition, no vertical support existed on the body side at the body-to-neck interface, as well as the rod that was designed to be threaded into the neck, in the hole adjacent to the red arrow in FIG. 9A, until Design 2, the second design cycle. The body plate thicknesses were thicker for Design 1, which was 3 mm, while Design 2 had a 2.5 mm body plate thickness.

Design 3, the third design cycle, was identical to Design 2 except that all previously SLS parts were converted into MJF Nylon 12 for printing in a limited equipment space.

### Material Properties.

Table 2 shows the material properties of the materials used for FEM, as obtained from [4], [5], [6], [7].

TABLE 2

| Name | SLS, Nylon 12 | MJF, Nylon 12 | 18-8 SS | Brass | Nylon |
|---|---|---|---|---|---|
| Parts | All 3D elements | All 3D elements | Threaded | Tailgut Nut | Tailgut |
| | except tailgut and | except tailgut and | Rod in the | | Cord |
| | neck threaded | neck threaded | neck | | |
| | rod | rod | | | |
| Young's Modulus | 1300 | 1700 | 193000 | 103400 | 4000 |
| (MPa) | | | | | |
| Poisson's Ratio | 0.35 | 0.39 | 0.305 | 0.35 | 0.4 |
| Ultimate Tensile | 46 | 48 | n/a | 1100 | n/a |
| Strength (MPa) | | | | | |
| Yield Tensile | n/a | n/a | 515 | 440 | 58 |
| Strength (MPa) | | | | | |
| Mass Density (g/cm³) | 0.95 | 1.01 | 7.93 | 8.409 | 1.2 |

### SOL 101 Loads.

FIG. 9B shows an example of tensile loading applied to the neck skeleton of SOL 101. The string tension loads were applied simultaneously at the independent nodes of RBE2 elements, where the spring elements were attached. The loads were applied parallel to the spring element angles, as can be seen by the orange arrows in FIG. 9B.

### SOL 101 Constraints.

FIG. 9C shows a bottom view and a top view of a violin with constraints. To mimic the clamping of the violin between the chin and the shoulder, the shoulder area on the baseplate of the violin body and the lofted area of the chin rest were constrained in all six degrees of freedom (6 DOF). The shoulder area was approximately 186 mm in the Y-direction, with the thinnest part in the X-direction approximately equal to 31 mm. The constraint assumed the left-hand fingers were the ones that push the strings down onto the fingerboard, but the support from the thumb was omitted to simulate the ideal playing form. As a result, the violin FEM resembled a cantilever beam, as can be seen in FIG. 9C.

### SOL 103 Constraints for Modal Analysis.

FIG. 9D shows the constraint configuration for SOL 103 FEM from a bottom view of the violin. For SOL 103, the constraints were applied in all 6 Degrees of Freedom (DOF) at each axial end of the violin body baseplate, as can be seen in FIG. 9D. Such was to simulate the existence of foam supports used for a typical modal analysis testing that limits all 6 DOF without impacting the frequency results, e.g., as shown in FIG. 9A. As a result, the SOL 103 FEA results could be compared with the modal testing results.

### SOL 101 FEA Results.

FIG. 9E shows FEA results for SOL 101 for the whole violin for Design 2, SLS. FIG. 9F shows FEA results for SOL 101 for the whole violin for Design 3, SLS. In FIGS. 9E and 9F, the static strength FEA stress results were extracted in the form of Node-Element, Nodal-Averaged Von Mises (VM) Stress results. In FIG. 9E, they were found to be under 46 MPa, the ultimate tensile strength of SLS, which is lower than that of MJF, for all three runs except for the areas of high stress concentration. The high-stress areas were where the glue simulation objects, constraints, and RBE2 were located, where the parts were more prone to fictitious stress concentrations from the fictitiously high local stiffness. As a result, the stresses from the nodes adjacent to the high-stress points were extracted for more realistic stresses and averaged, which were found to be less than the ultimate tensile strength of the material.

As can be seen in FIG. 9E, the region of relatively higher stress on the body plates increased in size when entering Design 2, which was most likely due to a decrease in body plate thickness. In Design 3, the VM stresses, especially the maximum VM stresses, decreased as can be seen in FIG. 9F, most likely due to the change in material properties, such as Young's Modulus, which directly affects the stiffness of the part.

### SOL 103 Background Information.

SOL 103 is based on the Equation of Motion (EoM) provider per Equation 1.

$$[ M ] \{ \ddot{x} ( t ) \} + [ C ] \{ \dot{x} ( t ) \} + [ K ] \{ x ( t ) \} = \{ f ( t ) \} \qquad ( Eq . 1 )$$

In Equation 1, \ddot{x}(t) is the acceleration, \dot{x}(t) is the velocity, x(t) is the displacement, f(t) is the load, [M] is the mass matrix, [C] is the damping matrix, and [K] is the stiffness matrix. Since modal analysis assumes a free and undamped system, meaning f(t) and [C] are equal to zero, the equation can be restated per Equations Set 2.

$$[ M ] \{ \ddot{x} ( t ) \} + [ K ] \{ x ( t ) \} = \{ 0 \} \qquad ( Eq . Set 2 )$$

$$det \vert [ K ] - {ω}^{2} [ M ] \vert = 0$$

In Equation Set 2, ω is the frequency of the object that the solver software (NX NASTRAN) tries to solve. From the equation, the reader can deduce that higher stiffness K and lower mass M will lead to a higher frequency.

### SOL 103 Results.

FIG. 9G, subpanels (a)-(d), show SOL 103 Results, Mode 5, for Design 2 (subpanels (a) and (b)) and Design 1 (subpanels (c) and (d)). The model is scaled to exaggerate the results. Scale=10% Model. Mode 5 was the mode with the highest modal effective mass fraction in all three x-, y-, and z-directions for both Design 1 and Design 2. Mode 5 frequency was 197.55 Hz for Design 2, while it was 194.71 Hz for Design 1. The higher frequency at mode 5 was most likely due to increased stiffness in the neck area from the inclusion of the threaded rod, as the body-only SOL 103 runs in FIG. 9G show a slightly lower frequency for Design 2, which had thinner body plates than Design 1. The frequency decrease was probably inhibited by the inclusion of the vertical support rod in the body, which provided more local stiffness in the z-direction without adding too much weight.

The existence of the vertical support rod in the body also seemed to tremendously affect the modal shape, as can be seen in FIG. 9G. The MJF mode 5 model had a nearly identical mode shape to those of Design 2, with a higher frequency, which was 219.01 Hz, a value that is approximately 11 percent higher than that of Design 2.

The modal effective mass fraction (MEMF), which shows the contribution each mode has to the total possible movement of the rigid body mass in each of the six directions in which the structure can move as a rigid body, seemed much lower for Design 1 than for Design 2 and Design 3. Table 3 shows SOL 103 Results, First Mode, and Modes with Maximum MEMF for each direction.

TABLE 3
Design 3 - Design 2 with SLS Parts Converted into MJF

| | | Translational Only | | | | | |
|---|---|---|---|---|---|---|---|
| | | T1 | | T2 | | T3 | |
| Mode No. | Frequency | Fraction | Sum | Fraction | Sum | Fraction | Sum |
| 1 | 92.91 | 0.00 | 0.00 | 0.00 | 0.00 | 0.03 | 0.03 |
| 5 | 219.01 | 0.00 | 0.05 | 0.00 | 0.01 | 0.53 | 0.64 |
| 16 | 497.35 | 0.13 | 0.59 | 0.00 | 0.05 | 0.00 | 0.68 |
| 35 | 812.84 | 0.00 | 0.66 | 0.24 | 0.73 | 0.00 | 0.75 |

Design 2 - Geometry and Features Changed from Design 1, SLS

| | | Translational Only | | | | | |
|---|---|---|---|---|---|---|---|
| | | T1 | | T2 | | T3 | |
| Mode No. | Frequency | Fraction | Sum | Fraction | Sum | Fraction | Sum |
| 1 | 83.60 | 0.00 | 0.00 | 0.00 | 0.00 | 0.03 | 0.03 |
| 5 | 197.55 | 0.00 | 0.05 | 0.00 | 0.01 | 0.54 | 0.64 |
| 14 | 417.86 | 0.12 | 0.45 | 0.00 | 0.03 | 0.00 | 0.68 |
| 17 | 466.59 | 0.00 | 0.59 | 0.18 | 0.22 | 0.01 | 0.70 |

Design 1 - Baseline, SLS

| | | Translational Only | | | | | |
|---|---|---|---|---|---|---|---|
| | | T1 | | T2 | | T3 | |
| Mode No. | Frequency | Fraction | Sum | Fraction | Sum | Fraction | Sum |
| 1 | 83.26 | 0.00 | 0.00 | 0.00 | 0.00 | 0.02 | 0.02 |
| 5 | 194.71 | 0.00 | 0.04 | 0.00 | 0.01 | 0.28 | 0.37 |
| 12 | 424.27 | 0.17 | 0.37 | 0.00 | 0.05 | 0.00 | 0.65 |
| 15 | 465.32 | 0.01 | 0.39 | 0.17 | 0.22 | 0.00 | 0.65 |

FIG. 9H, subpanels (a) and (b) show MEMF vs. frequency comparisons between Design 2 and 3 (subpanel (a)) and between Design 1 and 2 (subpanel (b)). As shown in subpanel (b), even the slightest frequency increase from mode 5 to mode 6 would lead to a large increase in MEMF in Design 1, to values similar to those of Design 2 and Design 3's mode 5.

FIG. 9I shows results for Body Only SOL 103 Result, Mode 2, Design 1 (Top) and Design 2 (Bottom). When the body is segregated from the rest of the assembly and SOL 103 is run with the constraints at the body base plate, the results differ between Design 1 and Design 2 as shown in FIG. 9I. The maximum MEMF was found in mode 2 for both Design 1 and Design 2, and when compared to each other, the mode shape differed, while the frequency was lower for Design 2. This is most likely due to the lower stiffness from the body plates being thinner compared to Design 1. Since a more robust acoustic profile can be reached when MEMF is more evenly distributed across a wider range of frequencies, Design 1 would have been preferred over Design 2. However, since the changes made for Design 2 also included the addition of the threaded rod in the neck, as well as the vertical support rod in the body chamber that added to the overall performance in both SOL 101 and SOL 103, Design 2, was preferred over those of Design 1 in FEA-based perspective, as the overall mass is also much lighter with less significant difference in results between the design cycles.

### Violin Neck Design

### FDM Testing & Iterations.

For neck break strength testing, when designing the violin, there were two main design concerns. First, the internal stresses of the torqued strings would be too large for the neck, resulting in a fracture of the neck piece. Secondly, there was concern that the tuning peg-to-neck interface would be too loose, and slippage between the tuning peg and neck would result in the instrument being unable to be properly tuned and/or the inability to hold a tune. To assess these chief concerns, the initial design was printed using a desktop FDM printer and ABS material. While it was known that this would not be the final manufacturing process or material, the goal of this initial print was to use an Instron machine to assess neck strength and tuning peg to neck slippage. Using available data, the results of this testing were correlated to the expected results for MJF, the final manufacturing process.

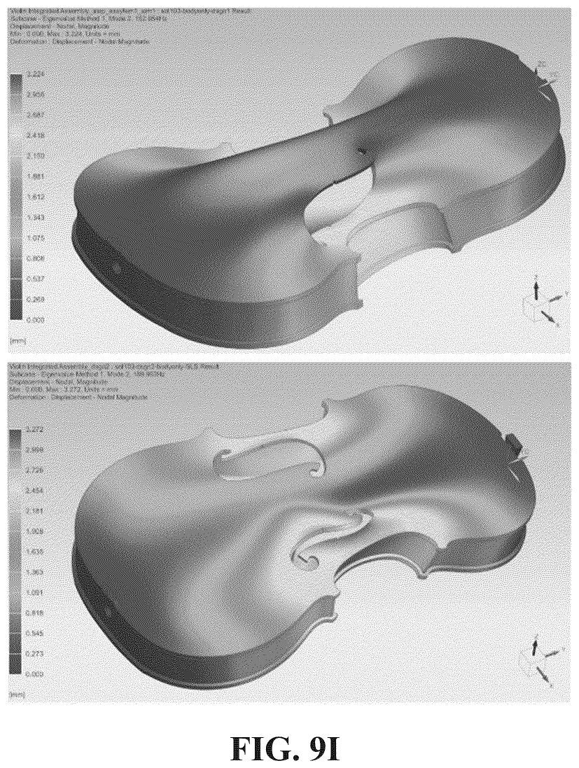

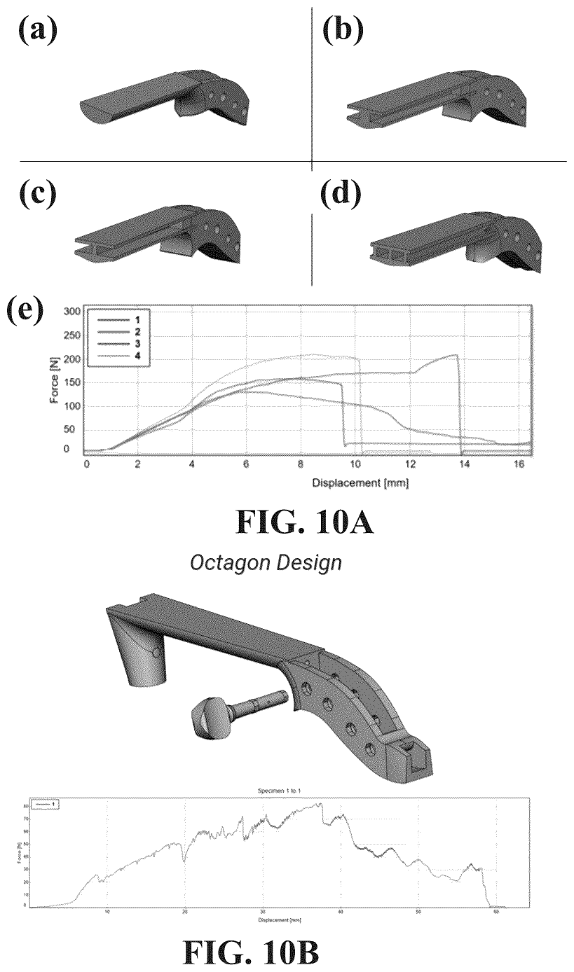

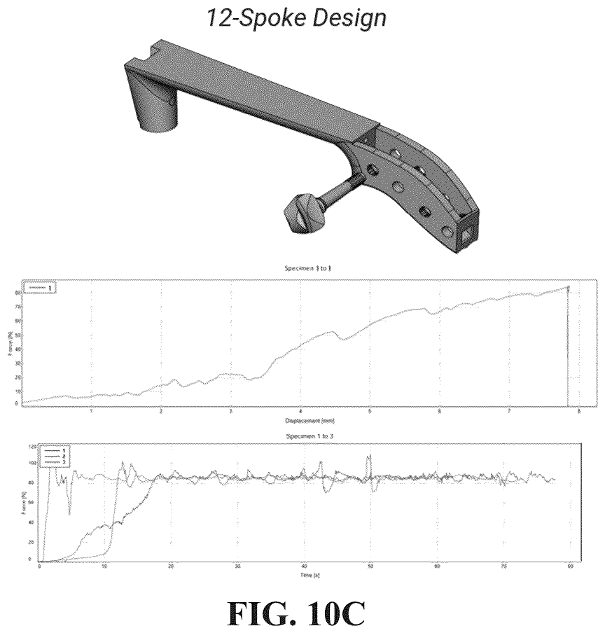

FIGS. 10A-10C show modeling and validation of violin neck design conducted in the study.

FIG. 10A, subpanels (a)-(d) show different neck design provided for neck break strength testing. To assess the neck strength, four unique neck designs were printed using a Stratasys Fortus 400mc FDM printer using Stratasys ABS-M30 material. The geometry was printed in the x-y plane. All parts were finished with a four-hour IPA bath to dissolve support material. The four neck designs are: replicative neck, I-beam neck, thin I-beam neck, and triple I-beam neck, and can be seen below in FIG. 10A.

To test the strength of the neck, a break force test was conducted on N=3 samples using an Instron for each of the four neck designs. The test utilized a radiused stainless-steel head, which was aligned to the center of the neck. The Instron test method was set up to compress the neck at a constant rate of 3 mm/minute until a break was detected. The results for each design were averaged into a single line. FIG. 10A, subpanel (e) shows the average break force of the replicative neck (1), I-beam neck (2), thin I-beam neck (3), and triple I-beam neck (4).

The stiffest neck was determined to be the full solid replicative design, with an average neck break force of 215 N. This design also withstood 4 mm of additional deflection before breakage. FDM printing results in different mechanical properties than MJF, both due to the manufacturing process as well as material properties. Based on available material and process data, it is expected that the final nylon MJF process should result in a 56% increase in ultimate strength compared to the ABS FDM process. Thus it was determined that the final replicative neck design should be able to withstand a force of 335 N [8, 9, 10]. This is substantially above the calculated total force of the torqued strings, confirming a full solid design as the optimal neck geometry moving forward.

Tuning Peg Torque Optimization. FIGS. 10B and 10C shows initial replicative neck and tuning peg design, respectively. With the full solid neck geometry performing best on the break strength test, a pull force test was performed on N=3 additional samples to determine the maximum force the tuning peg-neck interface could sustain. These samples were printed using the same Stratasys Fortus 400mc FDM printer with Stratasys ABS-M30 material, printed in the x-y plane, and finished with a four-hour IPA bath to dissolve support material. For this testing, a tuning peg was inserted into the neck, a wire string was wrapped around the tuning peg 4×, attached to a clamp on an Instron machine, and the neck was supported to prohibit movement (to isolate tuning peg-neck slippage). The Instron test was set up to pull the wire upwards at a constant 1 mm/second until a maximum force of 85N was reached.

In FIG. 10B, an image of the initial tuning peg-neck interface is shown along with the average breaking force. In FIG. 10C, an image of the 12-raised spoke tuning peg and neck design is shown along with the average breaking force results.

This testing found that the tuning peg-neck interface began slipping at 70 N, which is significantly lower than the force of a tuned E string. Because of this, the team brainstormed two novel tuning peg and neck interface designs that could help prohibit slippage by mechanically locking in the tuning peg to the neck. The first design utilized an octagon-shaped tuning peg and matching neck geometry. The second design used 12 raised spokes on the tuning peg with matching neck geometry.

For each of the two new tuning peg-neck designs, N=3 models were printed using the same FDM process as the previous parts. The same Instron pull test setup was repeated for each of the designs; results are summarized for the octagon design in FIG. 10B and for the 12-spoke design in FIG. 10C. The octagon design performed better than the initial replicative design, sustaining an average of 82 N; however, the 12-spoke design was able to sustain 85 N. With the 12-spoke design holding 85 N, a follow-up test was performed that held the strings at 85 N for one minute to assess any creep/relaxation risks; results are summarized in FIG. 10C. Because of the significant performance improvements, the team selected the 12-spoke tuning peg and neck design to move forward with. FIG. 10C also shows the results of holding 85 N over a 60-second duration for the 12-spoke design.

### Final Design and Adaptation to AM.

The design process of the violin employed a two-phase approach. Phase I produced the MK-I design, which was as accurate in dimensions and function as a classical wooden violin as possible. MK-I was synthesized from a combination of several sources, including online databases and physical measurements from a Snow SV200. The emulated design was then modified in Phase II to generate the MK-II build, which adapted the MK-I design for AM.

The overarching objective of MK-I was to emulate a wooden instrument as closely as possible in a 3D CAD environment. Many of the internal structures, such as the inner ribs, bass bar, soundpost, endpin, and linkage between the neck and body, were synthesized from online or print sources [11], [12], [13], [14], [15], [16], [17], [18], [19]. Great care was taken to capture the hand-carved nature of the instrument, even so much as including observed imperfections that make the violin, especially the scroll and body, look and feel authentic. The research team sought to make the instrument feel hand-carved, despite the obvious polymer structure and added weight.

Once MK-I was completed, the study modified the for AM in MK-II. First, preliminary calculations and simulations estimated that the neck would deflect approximately 15 mm. The classic neck and fingerboard design is a specific size and shape to enhance playability, so adding more material to improve strength would severely impact usability. Added strength instead came from a threaded stainless steel #4-40 rod inserted down the length of the neck. The optimal position of the rod relative to the side faces of the neck placed it outside the violin body, so a rectangular boss was added to the top of the body to receive the rod. A heat insert was added to the top of the boss, given the superior failure torque over Helicoil threaded inserts [12]. A counter torque screw was added to the heel at the back of the neck. A thin hex nut was added to the pegbox to torque the threaded rod. While not visually ideal, the strings and natural posture of the violin largely hide the hardware from the view of the audience.

Modern violins use a dovetail joint to better mate the neck assembly to the body. This was not feasible for the polymer violin, given the need for a front-protruding boss to receive the threaded rod. Therefore, the original rectangular boss was modified to a sloped dovetail that would press-fit the two assemblies together. An offset of 0.15 mm was used to ensure the polymer faces would snuggly mate instead of interfering. 9.

The study considered that under the string load, the course tuning pegs would slip and not hold a tune for a meaningful duration. The study added raised spokes near the tip of the peg where the spokes do not extend to the end of the peg but gently terminate 2.75 mm from the tip to allow the player to use the tip of the peg as a smooth guide while performing coarse adjustments. Once a desirable tune was reached, the peg spokes could be pushed inward and engaged with the receiving geometry on the pegbox.

The study merged the fingerboard and the neck into a common part to enhance strength and reduce post-processing. The study considered that the threaded rod could be sized up.

### Assembly.

The study used the MJF machine due to machine availability. Because MJF nylon 12 is comparable to SLS, no design adaptation was needed. The tolerances translated well of the design translated well between SLS and MJF, such that snap-fit joints fit snugly. The MIF neck could hold the weight of the body just by the snap-fit around the dovetail

In the study, the violin was first taken to a professional for soundpost setting. An exact and an elongated-length soundpost was printed with MJF, and the technician opted to sand down the 56 mm elongated post to fit between the top and bottom plates. The soundpost and bridge locations were marked on the top plate. In printing with MJF, one of the four course tuner pegs and fine tuner arms was printed. In response, fine-tuner arms were removed from a COTS tailpiece and installed in the MJF tailpiece structure. A COTS tailgut, spindle., locking pin, and knobs were installed in the tailpiece assembly after reaming the locking pin hole, the knob holes, and deepening the spindle channel with a razor blade. The latter process was required to engage the locking pin under the spindle. Helicoil or thermal may be installed to strengthen the fine-tuner threads.

The MJF course tuner peg received showed excellent tolerancing. The peg functioned exactly as intended and slid into the spoked receptacles in the pegbox with little effort. Rotating the peg was not difficult with the recessed spoke design, but untuning a string could take the user by surprise due to the sudden torque transferred from the pegbox to the hand. Ultimately, the 12-spoke peg design performed admirably but could be improved with either greater tooth resolution for less-course adjustments. In some cases, the peg would lock into the pegbox on a flat or sharp, and not in-between, and the fine tuners did not have enough range to reach the natural pitch. The study determined that better tooth resolution may be possible on the course tuners. Alternatively, the fine tuners may be adapted with a greater range.

4×SLA replacement pegs were printed using Formlabs Rigid 10k resin. For consistency, the single MJF peg was not used for acoustic testing, other than the tune test. The string interface hole in each peg was reamed before installation.

The holes for the heat inserts in the body dovetail were reamed, and the inserts were installed in the thermoplastic. The #4-40 threaded rod was cut from stock length 152.4 mm to 144 mm and was threaded into the forward insert, shown in FIG. 3B. The neck was inserted over the threaded rod and gently rocked into place around the dovetail. A washer and nut were installed and torqued.

Only 1× of each chin rest linkage type was printed, aside from the turnbuckles, which were not printed. From what was discernible from the chin rest linkages that were provided, more research is needed to adapt these to AM. Planned COTS linkages were used with the MJF chin rest in the final build. The chin rest holes were reamed, and the threaded stainless steel linkages were used to self-thread the polymer. Cork was cut in the shape of the bottom of the rest and was used to cushion the assembly against the body as it was tightened in place.

The tailgut was loosely installed around the endpin, and the tailpiece was left to rest on the top plate. The strings were hooked inside each peg and neatly wound to a loose tension. The bridge was installed at the marked position on the top plate, but the spacing of the D string relative to the adjacent strings was not consistent. The bridge was removed, and a new slot was cut slightly to the right of the original. With the bridge reinstalled, the strings were gradually tightened. When the exterior strings (G or E) were tightened, the bridge was observed to slide laterally over the top plate under the added downward force. Tightening the strings gradually as a group mitigated this effect. The top of the bridge would also warp when a string was pulled towards the scroll by the course tuners. This warpage could be readily relieved with minor finger tugging/squeezing on the affected zones until the top of the bridge again formed a straight line. The interference fit on the SLA course tuners made it difficult to disengage/reengage the pegs for gradual tuning. The lack of peg engagement also necessitated the overlap of the D and A strings, as the string engagement holes on the pegs were misaligned.

Dominant-brand medium synthetic core, silver-wound strings were used to match the strings on the wooden instruments used in testing.

The study observed a slight rotation of the neck forward around the rear screw due to the 240.6 N of string tension, which can create a gap between the back of the neck and the top of the body due to a loose rear screw. A larger counter torque screw or a second screw may be employed to offset this effect.

### Anechoic Chamber Evaluation

The study evaluated the quality of the 3D-printed violin sound by investigating acoustic quality and comparing data to two wood violins: a mid-tier Snow SV200 and a high-tier John Juzek Czechoslovakia 1948. The polymer MJF violin is hereby denoted as UUT-1 (unit under test 1), the Snow as UUT-2, and the John Juzek as UUT-3.

Acoustic violins translate the vibrations of the strings through the bridge, soundpost, bass bar, and the body structure, which vibrate to create air compressions that produce pressure waves. The resultant air compressions occur at the same frequency as the strings, as well as at harmonics, or multiples of the original resonance. These compressions may be read by sensitive microphones, which require a low-noise environment to distinguish significant compressions from the noise floor or other clutter.

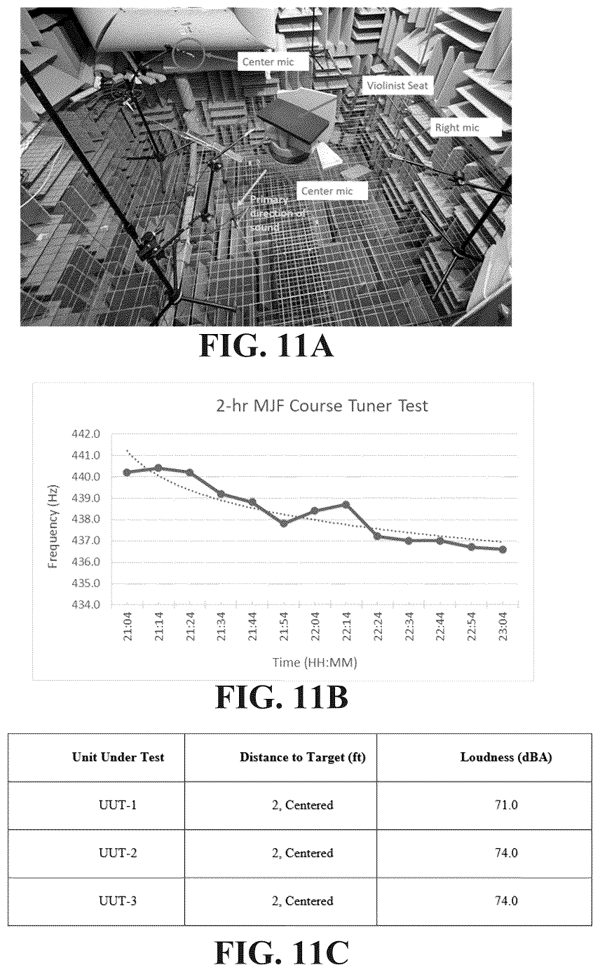

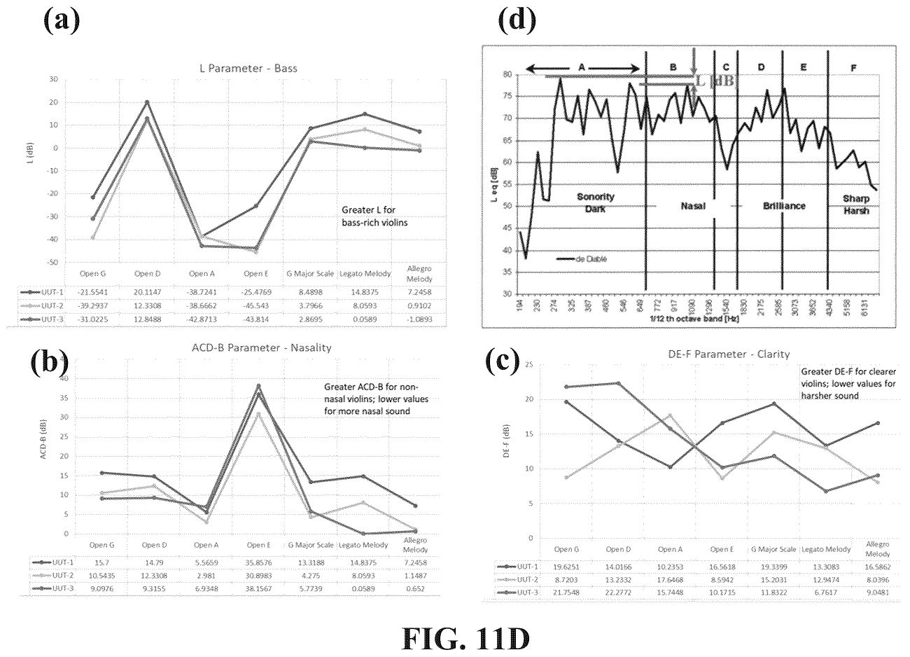

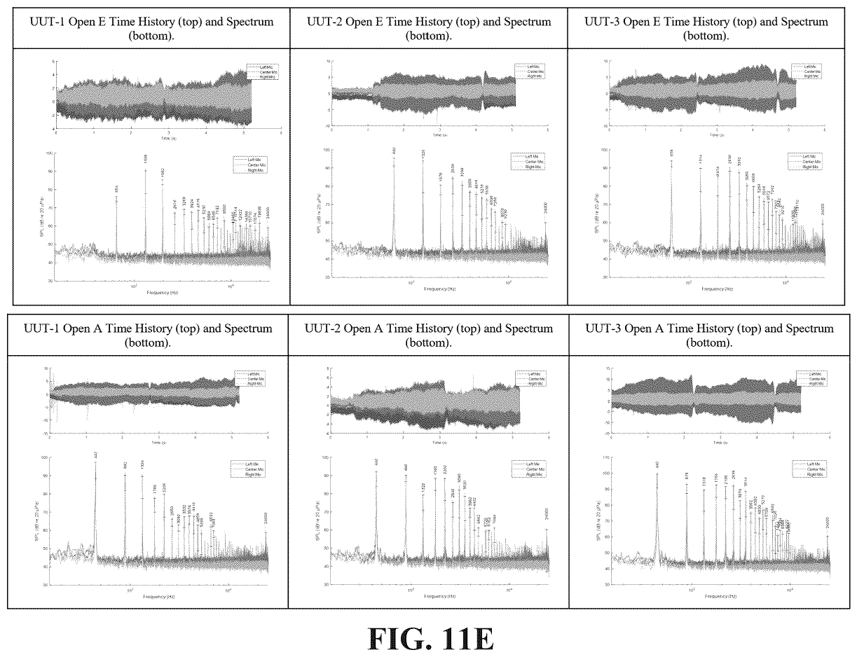

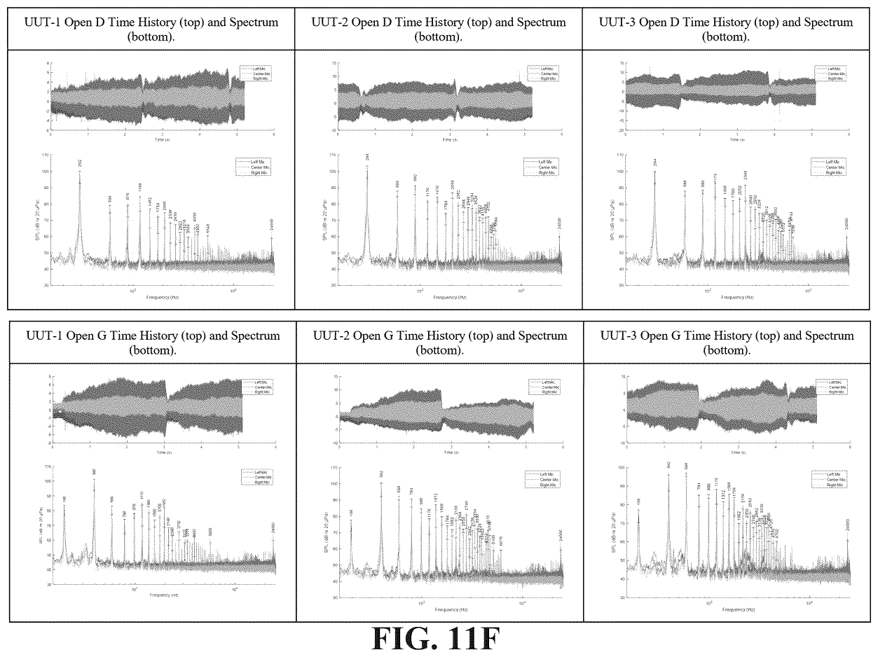

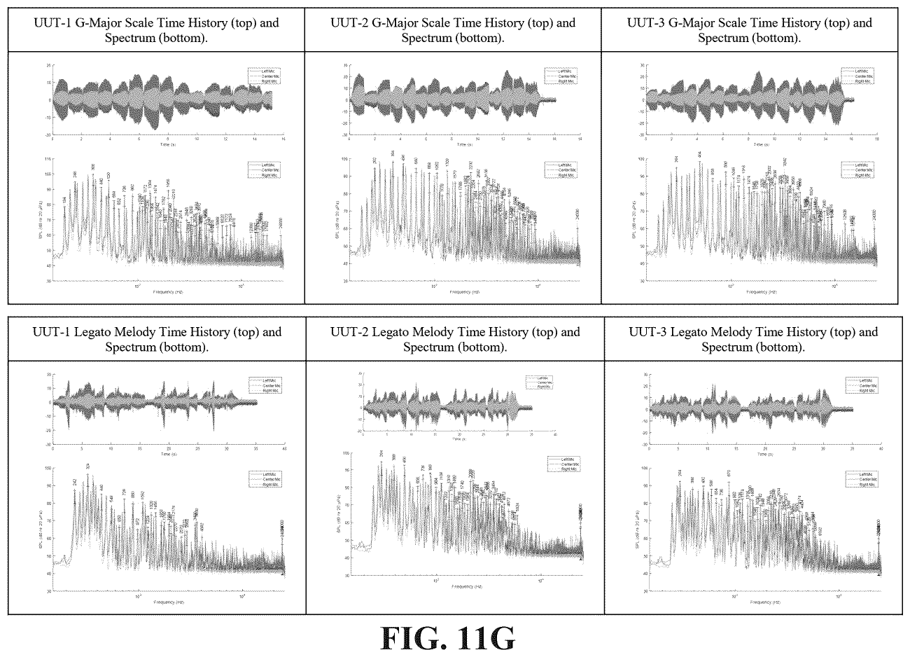

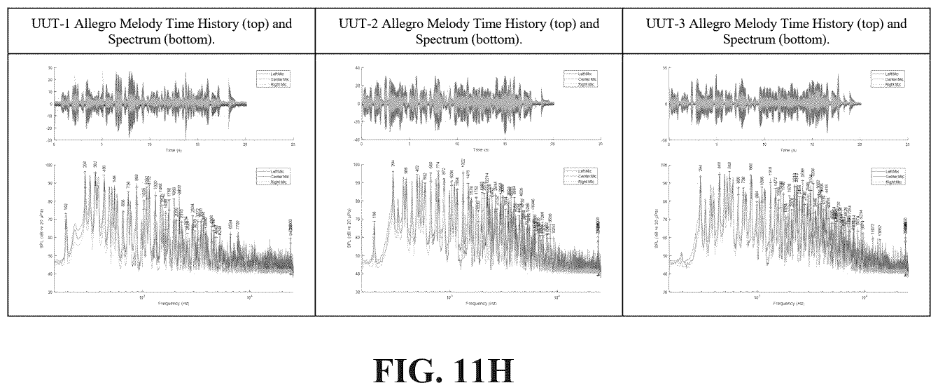

FIGS. 11A-11H show modal analysis via anechoic chamber for different acoustic performance and response conducted in the study.

FIG. 11A shows an anechoic chamber employed as the low-noise test environment. In the study, three PCB 378C01 ½-diameter microphones were mounted on tripods surrounding a stool where a violinist could sit. The microphones are free-field, meaning they measure sound pressure levels radiating from a single direction and a single source. The microphone layout and player orientation in the chamber are shown in FIG. 11A.

Four tests were conducted per UUT to assess a comprehensive range of sounds, tones, and play styles. Each instrument starts with open-string testing, which entails a 5-sec sample of the E (N.1.1), A (N.1.2), D (N.1.3), and G (N.1.4) strings, respectively, where N is the UUT identifier. The N.2 test consisted of an ascending-only 2-octave G-major scale in the first position using open strings and no vibrato. A legato melody, Le Cygne by Saint-Saens, was selected for the N.3 test as it has an excellent range across all strings and captures a smooth, slow, and flowing play style. The final test, N.4, showcases a faster allegro melody, in this case Bourrée by Bach. In addition to the N1-4 tests, other collections include: a pre- and post-ambient reading of the chamber environment, a loudness test (dBA), a tune-over-time test, a violinist qualitative assessment, and a consumer needs survey. All data was collected and processed using custom LabVIEW executables and MATLAB scripts.

### Functional Test Results.

For qualitative sound assessment, the qualitative feedback is integral to understanding the comprehensive result of the violin. Since every instrument is a unique work of art, the individual interaction musicians experience with resonance, tonal clarity, and overall feel of the violin tremendously impacts the performance.

Two violinists were asked to play the polymer MJF violin and provide feedback on the sound quality The first violinist indicated that the instrument held its tune well and had great tonal clarity, but noticed a decrease in sustain as the pitch of the string increased. Similar to the first participant, the second violinist observed great tonal clarity in the lower-pitch strings but perceived a metallic “tinny” sound in the E string. Violinist 2 also commented on the feel of the violin, saying the dimensions looked correct and that extra weight was not a huge distraction: “the instrument feels sturdy and comfortable on the shoulder.” They observed that the neck is smooth, which is good for shifting, but could be smoother.

The perceived decreased resonance in the E and A strings by both violinists matches up with the FEA analysis, indicating a decreased mass participation as pitch increases. Reducing the violin plate body thickness and overall mass is recommended to enhance the resonant frequencies. Additionally, a vertical z-axis support rod should be added internally to the violin body to combat increased stresses after thinning the body.

### 2-hr Tune Test.

FIG. 11B shows a 2-hr MJF course tuner test on A-String. The violin was assembled with three SLA course tuners and one MJF peg on the A-string. Each of the strings was tuned, and the MJF peg spokes were installed at engagement depth. The tune of the A-string was measured at 10-minute intervals for two hours to assess the rate of frequency change over time. The results are shown in FIG. 11B. Over a 2-hour period, the frequency decreased from 440.2 Hz to 436.6 Hz, or 0.821%. The violin was left in the tuned state and assessed again at the 15-hr mark, where it read a steady-state value of 336.0 Hz, which represents a 0.959% total change in frequency. This validates the spoke peg design as a highly effective means to maintain instrument tune over long periods.

### Loudness Test.

FIG. 11C shows the results of a measured loudness test on the Open-A string. A handheld decibel meter was used to measure the loudness of the UUTs in dBA. The meter was held at violin level, centered 2 feet from the violinist. The violinist played a consistent open A for each UUT. The results in Table 8 show that UUT-2/3 are slightly louder at 74.0 dBA than the polymer instrument at 71.0 dBA.

### 7Dunnwald Timbre Parameter Analysis.

FIG. 11D shows results for a 7Dünnwald Timbre Parameter Analysis. FIGS. 11D, subpanels (a)-(c) show the results for a

FIG. 11D, subpanel (d) shows a Dunnwald Long-Time Average Spectra Bands. Heinrich Dünnwald provided a quantitative assessment of violin timbre, notably via the expanded work performed by Anders Buen in the publication “On Timbre Parameters and Sound Levels of Recorded Old Violins” in 2007 [20]. Buen describes the methods used by Dunnwald to interpret the spectral responses of hundreds of violins, ranging from modem factory-made, amateur, or professional instruments to surviving Stradivari and Guarneri builds. Buen focuses on the Stradivari and Guarneri instruments, but uses the same parameters as Dunnwald to relate the sound spectra to qualitative “common word” adjectives like “dark” or “warm”, “nasal”, “brilliance” or “clarity”, and “sharp” or “harsh”. These descriptions relate to different frequency bands, shown in FIG. 11D, subpanel (d), which are given a corresponding letter name: A, B, C, D, E, and F.

A dark violin tone is attributed to a richness in the lower frequency bands (A) and has a warm, full-body resonance. This results in a more subdued or mellow timbre, which is often linked to a more expressive and intimate style. On the contrary, a nasal violin lacks warmth or depth at the lower frequencies, which leads to a thin sound with less emphasis on the lower frequencies. The sharper, more penetrating tone is the result of more prominent harmonics in the upper-frequency regions, so higher notes are especially susceptible to sounding shrill. A clear and brilliant violin produces well-defined, easily discernible, crisp notes that are bright and vibrant. There is little distortion in the sound, other than a classic shimmering from the rich harmonics and overtones that project very well for solo performances. Finally, a sharp or harsh violin creates a piercing sound that bites the tone without warmth or smoothness. Harsh tones are manifest from prominent high-frequency harmonics typically above 4200 Hz.

FIG. 11D, subpanel (a) shows the Timbre parameter “L,” which is calculated as the difference between the maximum sound pressure level (SPL) in the 244-325 Hz frequency band and the maximum SPL in the 649-1090 Hz band. It represents the bass level, where a higher L corresponds to a darker sound quality. Parameter ACD-B is the difference between the equivalent SPL level in the 190-650 Hz and 1300-2580 Hz bands and the equivalent SPL in the 650-1300 Hz band. ACD-B represents the nasality of the sound, where a greater ACD-B value corresponds to a more nasal sound. Finally, the DE-F parameter is calculated as the difference between the equivalent SPL in the 1640-4200 Hz band and the equivalent SPL in the 4200-6879 Hz band. DE-F represents the brilliance, or clarity of the sound, whereas a high DE-F indicates a clear or smooth tone. Higher values in region F correspond to a harsh or sharp sound. Each Dunnwald parameter is summarized by Equation Set 3 and has units in dB.

$$L ( dB ) = {L}_{max , 244 - 325 Hz} - {L}_{max , 649 - 1090 Hz} \qquad ( Eq . Set 3 )$$

$$ACD - B ( dB ) = {L}_{eq , 190 - 650 Hz \& 1300 - 2580 Hz} - {L}_{eq , 650 - 1300 Hz}$$

$$DE - F ( dB ) = {L}_{eq , 1640 - 4200 Hz} - {L}_{eq , 4200 - 6879 Hz}$$

The Dunnwald parameters were calculated from the acoustic data collected for each UUT and test type, and then are plotted in FIG. 11D, subpanels (a)-(c). The first four data points show the individual rankings of the open strings, followed by the G-major scale, legato melody, and allegro melody. The latter three tests are most relevant when compared to other Dunnwald parameters for violins outside of this study, as they represent more diverse, or averaged, spectra than those of the open string tests. However, the open string parameters are still useful to compare amongst the UUT-1/2/3 test population.

FIG. 11D, subpanel (a) shows the L parameter for bass for each UUT and test, and displays noticeable trends. All open strings sans the D exhibit negative values of L as the target frequency of open D—293.66 Hz—is the only string to fall within the 244-325 band in Equation Set 3. This effect is mitigated when sampling a more diverse spectrum, such as with the continuous tests: The G-major scale, the legato melody, and the allegro melody where a wide variety of notes are played across each string. As such, each UUT shows consistently decent bass across the continuous tests. The trend shown between each open string and continuous test indicates that this data represents typical performance across different violins, and a broader sample size would likely yield similar data.

UUT-1 consistently exhibits the best bass characteristics, followed by UUT-2, then UUT-3. This supports both qualitative assessments, stating that the instrument exhibits a deep, rich, or warm bass quality. For comparison, the average L reported by Buen for a Stradivari is −0.9 dB with a standard deviation of 2.9 dB.

FIG. 11D, subpanel (b) gives the nasality parameter, ACD-B, which yields a more nasal sound for a lower ACD-B value. Similar to the L parameter trends, the open E appears to exhibit very low nasality when analyzed alone, as the open E target frequency of 659.25 Hz is just outside of the 190-650 Hz range specified by Equation Set 3. As before, the open string values of ACD-B are useful to show trends, not necessarily to compare to other violins outside this test population. Once again, the continuous tests offer more insight into the nasality of the violin performance. Across a mixed spectrum in the last three columns, UUT-1 displays the least nasal sound, followed by UUT-2, then UUT-3. For comparison, the average ACD-B reported by Buen for a Stradivari is 1.9 dB with a standard deviation of 1.4 dB.

FIG. 11D, subpanel (c) shows broader data trends than the plots for L and ACD-B, which is not unexpected as the clarity parameter pertains to the higher harmonics with less total energy and more overall variability. As the final parameter, DE-F represents the clarity, or brilliance of the sound, where a greater DE-F yields a clear tone and a lower DE-F gives a harsh tone. For the continuous mixed-frequency tests, UUT-1 and UUT-3 both dip in clarity on the legato melody, suggesting that the faster playing style of the G-major scale and allegro melody may generally improve clarity. Overall, UUT-1 exhibits the clearest sound quality, followed by UUT-2, then UUT-3. Buen reports an average DE-F value of 12.1 dB for a Stradivari with a standard deviation of 1.2.

Based on the calculated Dunnwald parameters for UUT-1/2/3 for the continuous mixed-frequency tests, UUT-1 performs best on all three tone categories, followed by UUT-1, then UUT-3. Therefore, this study suggests the polymer MJF violin is well balanced between a warm, smooth, and brilliant sound. The warmth of the sound parallels the qualitative assessments of Violinists #1 and #2, especially for the lower strings, as does the more brilliant sound of the upper strings. Both violinists mentioned a tinny or metallic sound when playing fingered notes, which contrasts slightly with the clear tone predicted by the Dunnwald parameters.

The Dunnwald parameters are a useful tool for analyzing the timbre of a violin, though the method is not foolproof. UUT-1 ranked best for bass, nasality, and brilliance, though this is unlikely considering the qualitative assessments provided by professional violinists. Furthermore, none of the UUTs are competitive with a Stradivari or a Guarneri, as indicated by all three parameters, which indicates some level of uncertainty. This is likely attributed to a lack of documentation on the exact methods for how each parameter is calculated, though the approximation in this analysis is sufficient to adequately compare each UUT to each other. To further compare and contrast the UUTs, each of the test spectra is now analyzed directly.

TABLE 4

| Resonance | Test Observations |
|---|---|
| Open E | UUT-1 has a weak resonance around 659.25 Hz and jumps up to meet UUT-2/3 for the 2nd |
| | harmonic. This may explain the tinny sound mentioned in the qualitative assessments. Both |
| | UUT-2/3 have excellent brilliance characteristics starting at the 4th harmonic, but UUT-1 |
| | has much less intensity after 2600 Hz, resulting in moderate brilliance. Both UUT-2/3 have |
| | more significant harmonics between 4200-6879 Hz, indicating that UUT-1 is less harsh than |
| | the wooden counterparts. UUT-1 has many more prominent harmonics after 6879 Hz, |
| | though these likely do not impact the perceived sound. |
| Open A | UUT-1 has a strong 3rd harmonic at 1324 Hz, giving a more nasally sound than UUT-2/3. |
| | The high 3rd harmonic on UUT-1 may explain the tinny sound mentioned in the qualitative |
| | assessments. The 4th and 5th harmonics are less significant than UUT-2/3, so UUT-1 does |
| | not match the brilliance of its wooden counterparts. UUT-3 has significant peaks past 4200, |
| | indicating a harsher tone. |
| Open D | Each starts strong around 293.66 Hz and slopes off with some peaks outside of the |
| | downward curve. The 2nd and 3rd harmonics for UUT-1 are not as significant, making the |
| | sound more direct, but have less intensity past 4200 Hz, making the sound less harsh. UUT- |
| | 2/3 have good brilliance qualities in the 1640-4200 Hz range. |
| Open G | Overall, a similar shape between UUT-1/2/3, though UUT-1 drops off faster. UUT-3 has |
| | more prominent higher-level harmonics, which give it a better ring. |
| G-Major | UUT-2/3 displays more brilliance, but also more harshness. Each UUT muffles the open E |
| Scale | around 659.25 Hz. |
| Legato | Each UUT muffles open E around 659.25 Hz, though UUT-1 does this most significantly. |
| Melody | Each UUT acts like a low-pass filter, with the cutoff frequency around 4082 Hz for UUT-1, |
| | 5924 Hz for UUT-2, and 6592 Hz for UUT-3. This may account for a deeper, richer sound |
| | on UUT-3. |
| Allegro | As before, UUT most prominently muffles the open E. Most harmonics past 2300 Hz for |
| Melody | UUT-1 are under 70 dB, showing a drop-off in brilliance but also harshness, but still enough |
| | for good quality. As before, UUT-1 drops off significant harmonic first, while UUT-3 has |
| | higher harmonic action. UUT-2/3 have much less intense peaks immediately after 293.66 |
| | Hz. |

Table 4 shows results for the different resonance sounds.

Per Table 4, the combination of these per-test analyses of the spectra concludes that the open G and D strings are competitive in sound quality to the wooden counterparts. The open A string is moderately competitive, while the open E is less competitive but not undesirable.

FIG. 11E shows results for UUT-1/2/3 (left, center, right) Shared Peaks and Troughs for the open E and A strings using the analysis technique described in [7]. The results show that the polymer violin E and A strings can be moderately competitive in sound quality to the wooden counterpart. Further reduction of mass in the z-direction may enhance the acoustic response of the upper registers. FIG. 11F shows results for UUT-1/2/3 (left, center, right) Shared Peaks and Troughs for the open D and G strings using the analysis technique described in [7]. The results show that the polymer violin D and G strings can be highly competitive in sound quality to the wooden counterparts.

FIGS. 11G-11H show results for UUT-1/2/3 for various play styles (e.g., a steady G-major scale, a legato melody, an allegro melody) across all strings. The data shows the polymer violin can be highly competitive in sound quality to the wooden counterparts.

### Economic Analysis.

Entry-level violins start around $300.00 and quickly increase in price, with top-of-the-line models listed at $20,000.00. Furthermore, top-of-the-line Stradivari violins have an estimated value of $8-20 million [1]. This large range of prices is due to manufacturers using a range of manufacturing techniques, wood, and varnish. Although hand-crafted, cheaper instruments are quickly mass-manufactured in factories with inexpensive materials. A more expensive violin is typically handcrafted by a master luthier, who can expertly select the highest quality wood, varnish, and practices for the instrument to optimize the sound output and quality. The study assessed the economic viability of our project using SLS manufacturing with Nylon 12 material. The study considered both an EOS P110 SLS machine capable of low part throughput and a significantly larger EOS P770 SLS machine capable of high part throughput.

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with programming techniques with rule-based logic and other logic to accomplish the various connection steps, processing steps, comparison steps, and decision steps.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] Rufino, C. (2022, August 22). Top 5 best violin makers of all time: Long island violin shop. The Long Island Violin Shop. https://www.liviolinshop.com/blogs/the-long-island-violin-shop-blog/top-5-best-violin-makers-of-all-time
[2] Barber, J. (n.d.). Parts of the Violin. Suzuki Violin Lessons. https://jasonbarber.weebly.com/parts-of-the-violin.html
[3] Hiziroglu, S. (2016, April 1). Using wood for violin makers—Oklahoma State University. Using Wood for Violin Makers. https://extension.okstate.edu/fact-sheets/using-wood-for-violin-makers.html
[4] Macassar Ebony. Wood Database. (n.d.). https://www.wood-database.com/macassar-ebony/#google_vignette
[5] East Indian Rosewood. Wood Database. (n.d.). https://www.wood-database.com/east-indian-rosewood/
[6] Green, D. W., Winandy, J. E., & Kretschmann, D. E. (n.d.). Chapter 4, Mechanical Properties of Wood. https://uccshes.files.wordpress.com/2012/09/mechanical-properties-of-wood-_usfs.pdf
[7] Schleske, M. Modal Analysis. (n.d.). Martin Schleske. https://www.schleske.de/en/research/introduction-violin-acoustics/modal-analysis.html
[8] Best-in-class 3D printers. Formlabs. (n.d.). https://formlabs.com/store/materials/nylon-12-powder/
[9] Multipurpose PA 12 for Industrial 3D printing: EOS. EOS. (n.d.). https://www.eos.info/en-us/polymer-solutions/polymer-materials/multipurpose #pa-2200-balance
[10] ABS-M30. (n.d.). Stratasys. https://www.stratasys.com/en/materials/materials-catalog/fdm-materials/abs-m30/
[11] Tension Chart—Violin Strings. Warchal. (n.d.). https://warchal.com/tension_chart_violin.html
[12] Helicoils, Threaded Inserts and Embedded Nuts in 3D Prints—Strength & Strength Assessment. (2020 May 30). CNCKitchen. https://www.cnckitchen.com/blog/helicoils-threaded-insets-and-embedded-nuts-in-3d-prints-strength-amp-strength-assessment
[13] The Violin Making Manual. (n.d.). Making The Violin. http://www.makingtheviolin.com/
[14] How A Violin is Made: Shaping the Ideal Tone. (n.d.). Yamaha. https://www.yamaha.com/en/musical_instrument guide/violin/manufacturing/manufactu ring002.html
[15] Two Cherries Instruments. (2019 July 10). Making a Violin Part 16 | CNC Violin Neck Guaneri “Vieuxtemps” [Video]. YouTube. https://www.youtube.com/watch?v=uWCimeKzh1k&ab_channel=TwoCherriesInstrume nts
[16] Designing a 3D Printed Acoustic Violin. (2016, August 8). FormLabs. https://formlabs.com/blog/designing-a-3d-printed-acoustic-violin/
[17] Greg Brown—Onshape. (2023, June 22). A CAD Journey Through a Parametric Violin [Video]. YouTube. https://www.youtube.com/watch?v=7eQNhvCtzEw&ab_channel=GregBrown-Onshape
[18] Bass Bar. (n.d.). Making The Violin. http://www.makingtheviolin.com/Bass %20bar
[19] Ossman, B. (2009). Violin Making: An Illustrated Guide for the Amateur 2nd Edition. Fox Chapel Publishing.
[20] Buen, A. (2007). On timbre parameters and sound levels of recorded old violins. J. Violin Soc. Am.: VSA Papers, 21(1), 57-68.
[21] Formiga P110 Velocis. EOS. (n.d.). https://www.eos.info/en-us/polymer-solutions/polymer-printers/formiga-p-110-velocis#key-features
[22] EOS P 770. EOS. (n.d.). https://na.eos.info/Equipment/Polymer-Platforms/EOS-P-770
[23] MacCallum, J., & Hajdu, G. (n.d.). Timbre. Science of Music. Retrieved from https://mutor-2.github.io/ScienceOfMusic/units/06/#:˜:text=Timbre %20itselfo20is %20not %20measu reable,measureab le %2C%20such%20as%20the%20spectrum
[24] Rozzi, C. A., Voltini, A., Antonacci, F., Nucci, M., & Grassi, M. (2022). A listening experiment comparing the timbre of two Stradivari with other violins. The Journal of the Acoustical Society of America, 151(1), 443-450.
[25] Setragno, F., Zanoni, M., Sarti, A., & Antonacci, F. (2017, August). Feature-based characterization of violin timbre. In 2017 25th European Signal Processing Conference (EUSIPCO) (pp. 1853-1857). IEEE.
[26] What Does the Violin Sound Like?. Cremona Amorim. (n.d.). https://amorimfineviolins.com/our-blog/the-best-violin-sound-for-you/
[27] Giraldo, S., Waddell, G., Nou, I., Ortega, A., Mayor, O., Perez, A., . . . & Ramirez, R. (2019). Automatic assessment of tone quality in violin music performance. Frontiers in Psychology, 10, 414378.
[28] Charles, J. (2010). Playing technique and violin timbre: Detecting bad playing.
[29] Breen N P, Ahuja K K. Subsonic jet noise source location as a function of nozzle exit boundary layer. International Journal of Aeroacoustics. 2022; 21(5-7):537-557. doi:10.1177/1475472X221107370.

What is claimed:

1. A fully acoustic violin or viola comprising:
an additively manufactured polymer body as a sound box for amplifying sounds produced by strings, the additively manufactured polymer body having a top and a bottom connected by ribs to form an hour-glass shape, wherein the top has a sound hole or holes, and wherein the top, bottom, and ribs have a thickness profile to amplify a pre-defined acoustic profile for the sound box; and
an additively manufactured polymer neck fixably coupled to the additively manufactured polymer body, the additively manufactured polymer neck having a reinforcing rod that, in combination with the polymer neck, provides a stiffness-to-weight ratio to generate tone, tonal clarity, and sound, matching a pre-defined acoustic profile.

2. The fully acoustic violin or viola of claim 1, wherein the additively manufactured polymer body and additively manufactured polymer neck have modified thickness and shape to account for a difference in ductility and density of the polymer to closely match a wooden body and wooden neck of a counterpart of the same or similar design.

3. The fully acoustic violin or viola of claim 2, wherein the modified thickness and shape are determined via structural strength and frequency response analysis and modal simulations, and wherein the simulation of the modified thickness and shape confirmed the additively manufactured polymer body and additively manufactured polymer neck are configured to withstand combined tensions of the strings without deformation or long-term creep.

4. The fully acoustic violin or viola of claim 1, wherein the additively manufactured polymer neck terminates at a polymer scroll end forming a pegbox to receive a set of tuning pegs for attachment, winding, and adjustment to the strings, wherein the pegbox has a set of peg holes each having a set of teeth to mechanically maintain tuning of the peg and strings.

5. The fully acoustic violin or viola of claim 1, wherein the additively manufactured polymer body and additively manufactured polymer neck are manufactured using selective laser sintering (SLS), multi jet fusion (MJR), stereolithography (SLA), or equivalent isotropic additive manufacturing process.

6. The fully acoustic violin or viola of claim 1, wherein at least one of the additively manufactured polymer body and additively manufactured polymer neck is made of nylon or a liquid photopolymer resin.

7. The fully acoustic violin or viola of claim 1, wherein the additively manufactured polymer body and additively manufactured polymer neck are dimensioned as a full-size violin or viola.

8. The fully acoustic violin or viola of claim 1, wherein the additively manufactured polymer body and additively manufactured polymer neck are dimensioned as a sub-size violin or viola.

9. The fully acoustic violin or viola of claim 1, wherein the additively manufactured polymer body and additively manufactured polymer neck are fabricated as a single unitary polymer body.

10. The fully acoustic violin or viola of claim 1, wherein the additively manufactured polymer body and additively manufactured polymer neck are fabricated as two or more components that are joined.

11. The fully acoustic violin or viola of claim 1, wherein the additively manufactured polymer neck is printed with a rod channel for insertion of the reinforcing rod, wherein the channel and reinforcing rod extend between a bottom end of the additively manufactured polymer neck and a top end of the additively manufactured polymer neck.

12. The fully acoustic violin or viola of claim 1, wherein the top of the additively manufactured polymer body has a uniform or variable thickness plate that is supported by a bass bar and a sound post, wherein the top plate is elongated to that of a counterpart of a same or similar design to withstand downwards forces from a bridge positioned over the bass bar and a sound post.

13. The fully acoustic violin or viola of claim 1, wherein the additively manufactured polymer body has a first portion of a joint, wherein the additively manufactured polymer neck has a second portion of the joint, and wherein counter-torque fasteners are employed.

14. The fully acoustic violin or viola of claim 1, wherein the additively manufactured polymer neck includes an additively manufactured polymer fingerboard.

15. A method of manufacturing a violin or viola comprising:
printing an additively manufactured polymer body as a sound box for amplifying sounds produced by strings, the additively manufactured polymer body having a top and a bottom connected by ribs to form an hour-glass shape, wherein the top, bottom, and ribs has a thickness profile to amplify a pre-defined acoustic profile for the sound box;
printing an additively manufactured polymer neck, the additively manufactured polymer neck having a reinforcing rod channel for placement of a reinforcement rod that, in combination with the polymer neck, provides a stiffness-to-weight ratio to generate tonal clarity and sound matching a pre-defined acoustic profile;
attaching the additively manufactured polymer neck to the additively manufactured polymer body; and
installing the reinforcing rod into the reinforcing rod channel.

16. The method of claim 15, wherein the additively manufactured polymer body and additively manufactured polymer neck are manufactured using selective laser sintering (SLS), multi jet fusion (MJR), stereolithography (SLA), or equivalent isotropic additive manufacturing process.

17. The method of claim 15, comprising:
determining, via structural strength and frequency response analysis and modal simulations, thickness and shape of the additively manufactured polymer body and the additively manufactured polymer neck, wherein the structural strength and frequency response analysis and modal simulations determine the thickness and shape can withstand combined tensions of the strings without deformation or long-term creep for the additively manufactured polymer body and the additively manufactured polymer neck.

18. The method of claim 15, wherein the additively manufactured polymer body and additively manufactured polymer neck are fabricated as a single unitary polymer body.

19. The method of claim 15, wherein the additively manufactured polymer body and additively manufactured polymer neck are fabricated as two components that are joined, wherein the additively manufactured polymer body has a first portion of a dovetail joint, and wherein the additively manufactured polymer neck has a second portion of the dovetail joint.

20. The method of claim 15, wherein the additively manufactured polymer neck includes at least one of: an additively manufactured polymer fingerboard, a set of additively manufactured polymer pegs, an additively manufactured polymer chin rest, an additively manufactured polymer tailpiece, a soundpost, endpin, and bridge.
